(19) United States
(12) Patent Application Publication
(10) Pub. No.: US 2022/0242799 A1
(43) Pub. Date: Aug. 4, 2022

(54) SYSTEM AND DEVICE FOR COMPOSTING

(71) Applicant: Open Mind Developments Corporation, Kelowna (CA)

(72) Inventors: Chim Bik Ying, Liverpool (GB); Rama Leung Wai Man, Hong Kong (HK); Daanvir Karan Dhir, Kelowna (CA); Jeremy Anthony Lang, Saskatoon (CA); Shay Eliezer Levy, West Vancouver (CA)

(73) Assignee: Open Mind Developments Corporation, Kelowna (CA)

(21) Appl. No.: 17/591,903

(22) Filed: Feb. 3, 2022

Related U.S. Application Data
(60) Provisional application No. 63/145,515, filed on Feb. 4, 2021.
(60) Provisional application No. 63/254,604, filed on Oct. 12, 2021.

(51) Int. Cl. C05F 9/02; B01D 46/00; B01D 46/24; C05F 9/04; B02C 18/06; B02C 18/24

(52) U.S. Cl. CPC C05F 9/02; B01D 46/0043; B01D 46/0049; B01D 46/2411; B01D 2273/30; C05F 9/04; B02C 18/067; B02C 18/24; B01D 46/0038

(57) ABSTRACT

In one embodiment there is provided a system and device for composting food waste and non-food waste compostable biopolymer materials together to create a compost.

### CROSS REFERENCE TO RELATED INVENTIONS

The present invention claims priority to U.S. Provisional Application 63/145,515 filed Feb. 4, 2021 and U.S. Provisional Application 63/254,604 filed Oct. 12, 2021, both applications are incorporated by reference in their entirety.

### FIELD OF THE INVENTION

The present invention relates to a system and device for composting food and compostable materials.

### BACKGROUND OF THE INVENTION

Composting devices are known to implement a composting cycle for biologically and chemically decomposing refuse, such as organic food waste, into compost for use as a fertilizer and soil amendment. The composting cycle may be implemented in a composting bin by providing water, heat and aeration to the refuse, and may require a period of time for completion. Composting devices usually require a large floor space and/or a large volume for installation. Further, some composting devices may be a batch type device, therefore may not be effective in producing compost in a continuous way. However, most composting devices do not handle non-food waste compostable materials.

Therefore, there is a need for a system and device for composting both organic food waste and non-organic food water, such as compostable biopolymer materials.

### SUMMARY OF THE INVENTION

In one embodiment of the present invention there is provided a composting device having a heating system, air circulating system, and a grinding system. The composting device is configured to compost both food waste and bioplastic compostable materials.

The various embodiments of the present invention can be outlined in a first embodiment defined to include a composting device having a housing with a hinged lid and a composting region for receiving compostable waste material. The composting device further includes a removable bucket, an air circulation system, a grinding mechanism and a heating mechanism, along with software working to control a composting cycle.

The removable bucket is positioned within the housing for receiving the compostable waste material and is secured onto a pedestal around a base plate that is sized to receive the bucket. The base plate includes protruding edges configured to receive notches on a lower portion of the bucket to prevent the bucket from rotating.

The air circulation system includes a fan configured to draw air from a top portion of the bucket into an airflow cover and through a first air filter system and into a second air filter system before the air is vented out of the composting device. The grinding mechanism is located within the removable bucket. And lastly, the heating mechanism includes a heating element positioned below the base plate and configured to heat the base plate when activated.

The composting cycle, when activated causes the compostable waste material positioned in the removable buck to compost and the composting cycle includes: (a) a first drying phase to heat and dry the compostable waste material, (b) a second grinding phase to grind the compostable waste material, and (c) a cooling phase.

The first embodiment is further defined by having the first air filter system configured to include a tubular filtration holder positioned above the fan such that the fan draws air through the tubular filtration holder and into an outlet conduit. The first embodiment is further defined by having the second air filter system connected to the outlet conduit and including a filter box that is positioned adjacent to a rear access door. The tubular filtration holder and the filter box may be defined to be removable from the composting device but are not disposable. Thus, both the tubular filtration holder and the filter box are configured to permit the removal of spent charcoal pellets and permit the addition of new charcoal pellets. The first embodiment may further include a scented pellet configured to be added to either the tubular filtration holder or the filter box.

The first embodiment is yet further defined to have the grinding mechanism include multiple grinder blades rotated by a gear that is driven by a motor and gearbox. The grinding mechanism is further defined to have an L shaped plate configured with an arm positioned and secured along a groove defined in a side of the bucket, and further configured with a leg extending towards the center of the bucket. The leg includes an upper leg section, a downward extension, and a lower leg section. The blades are then configured such that when rotating one or more of the blades travel over the upper leg section, while the remaining blades travel under the upper leg section such that the movement of the blades over and under the upper leg section grinds the waste in the bucket.

The first embodiment may further define the composting cycle to include a preliminary pulverization phase.

In a second embodiment of the present invention there is provided a household composting device. The device has a housing with a hinged lid and a composting region for receiving compostable waste material. The composting device further includes a removable bucket, an air circulation system, a grinding mechanism, a heating mechanism, and a composting cycle defined to control the various systems and mechanisms and which when activated composts the compostable waste material positioned in the removable bucket.

The second embodiment further defines the removable bucket as being positioned within the housing for receiving the compostable waste material. The removable bucket is secured onto a pedestal around a base plate and is sized to receive the bucket. The base plate includes protruding edges sized to receive notches on a lower portion of the bucket to prevent the bucket from rotating.

The second embodiment further defines the air circulation system to include a fan configured to draw air from a top portion of the bucket into an airflow cover and through a first air filter system and into a second air filter system before the air is vented out of the composting device. The first air filter system is configured to include a tubular filtration holder positioned above the fan such that the fan draws air through the tubular filtration holder and into an outlet conduit. The second air filter system is configured to connect to the outlet conduit and includes a filter box that is positioned adjacent to a rear access door.

The second embodiment locates the grinding mechanism within the removable bucket. And the heating mechanism which includes a heating element is positioned below the base plate and configured to heat the base plate and thus the bucket when activated.

The composting cycle, for the second embodiment, includes (a) a first drying phase to heat and dry the compostable waste material, (b) a second grinding phase to grind the compostable waste material, and (c) a cooling phase.

The second embodiment may define both the tubular filtration holder and the filter box as being removable from the composting device but not disposable, such that both the tubular filtration holder and the filter box are configured to permit the removal of spent charcoal pellets and the addition of new charcoal pellets. In addition, a scented pellet can be configured to be added to either the tubular filtration holder or the filter box.

The second embodiment may further define the grinding mechanism to include multiple grinder blades rotated by a gear that is driven by a motor and gearbox. The grinding mechanism may further include an L shaped plate defined to have an arm positioned and secured along a groove defined in a side of the bucket, the defined to further have a leg extending towards the center of the bucket, an upper leg section, a downward extension, and a lower leg section. The blades are configured such that when rotating one or more of the blades travel over the upper leg section, while the remaining blades travel under the upper leg section such that the movement of the blades over and under the upper leg section grinds the waste in the bucket.

In a third embodiment there is provided a method for composting with a household composting device. The device is defined to have a housing with a hinged lid and a composting region for receiving compostable waste material. The method includes the steps of (a) adding compostable waste material to a removable bucket positioned in housing; (b) activating a composting cycle, which includes the sub-steps of; (c) circulating air through the system by drawing air with a fan from a top portion of the removable bucket into an airflow cover and through a first air filter system and then into a second air filter system before venting the air out of the composting device; and (d) wherein grinding of the compostable waste material is configured by having a grinding mechanism located within the removable bucket, and wherein heating of the compostable waste material is configured by having a heating mechanism configured to heat the bucket when activated.

The third embodiment further defines the step of activating a composting cycle to include the sub-steps of: (i) a first drying phase to heat and dry the compostable waste material; (ii) a second grinding phase to grind the compostable waste material; and (iii) a final cooling phase.

The first drying phase may be defined to heat and dry the compostable waste material and include the steps of raising the temperature within the bucket and monitoring the humidity within the bucket to adjust the temperature to a final drying phase temperature as the humidity reaches a predetermined range; and grinding the compostable material during the first drying phase.

The second grinding phase may be defined to grind the compostable waste material and include the steps of maintaining the temperature and humidity within the bucket to a predetermined constant range; and grinding the compostable waste material until an amplitude on the motor falls below a predetermined value for a predetermined time interval to define a grinding phase completion.

The final cooling phase may be defined to shut off the heating mechanism while grinding the compostable waste material and shut off the grinding mechanism when a predetermined cooling off temperature is detected.

The third embodiment may further include an initial pulverization phase prior to the first drying phase. The pulverization phase may be defined to include the steps of increasing the temperature within the bucket while grinding the compostable waste material until an amplitude on the motor falls below a predetermined value for a predetermined time interval to define a stage one completion within the pulverizing phase; and decreasing the temperature within the bucket after stage one completion is achieved.

The third embodiment may further define the first air filter system as being configured to include a removable tubular filtration holder positioned above the fan such that the fan draws air through the tubular filtration holder and into an outlet conduit. And yet further define the second air filter system as being connected to the outlet conduit and include a removable filter box that is positioned adjacent to a rear access door. The removable tubular filtration holder and the removable filter box are removed from the composting device, but are not disposable, as both are configured to permit the removal of spent charcoal pellets and the addition of new charcoal pellets. The third embodiment may further allow for the step of adding a scented pellet to either the tubular filtration holder or the filter box.

The third embodiment may define the grinding mechanism to include an L shaped plate defined to have an arm positioned and secured along a groove defined in a side of the bucket, and have the L shaped plate further include a leg extending towards the center of the bucket. The leg may include an upper leg section, a downward extension, and a lower leg section. The grinding mechanism may define blades configured such that when rotating one or more of the blades travel over the upper leg section, while the remaining blades travel under the upper leg section such that the movement of the blades over and under the upper leg section grinds the waste in the bucket.

A fourth embodiment of the present invention may be defined as a method for composting with a composting device having a composting region for receiving compostable waste material. The method may include the steps of (a) receiving compostable waste material into the composting region; (b) allowing activation of a selected composting cycle from a set of composting cycles the household composting device can perform; and (c) monitoring the household composting device's performance of the selected composing cycle.

The fourth embodiment may further define the set of composting cycles to include a bioplastics cycle for composting of compostable waste material that comprises at least some bioplastics or browns, and at least one conventional cycle. The set of composting cycles may further include one or more phases. Each phase may have one or more phase start triggers, phase end triggers, and housing system operating parameters. Each phase may be defined to enable one or more housing systems based on the household composting device system operating parameters.

The fourth embodiment may further define the bioplastics cycle as including the following phases: (a) a drying phase to heat and dry the compostable waste material; (b) a grinding phase to grind the compostable waste material; and (c) a cooling phase to cool the compostable waste material. The bioplastics cycle may further define (a) during the drying phase the heating and drying of the compostable waste material is enabled by a heating mechanism configured to heat the composting region when activated; (b) during the grinding phase the grinding of the compostable waste material is enabled by the grinding mechanism located within the composting region; and (c) during the cooling phase the cooling of the compostable waste material is enabled by drawing warm air with a fan from a top portion of a removable bucket in the composting region and venting the warm air out of the composting device.

The fourth embodiment may further define the grinding phase to include (a) increasing the temperature within the bucket while grinding the compostable waste material until an amplitude on the motor falls below a predetermined value for a predetermined time interval to define a stage one completion within the grinding phase; and (b) decreasing the temperature within the bucket after stage one completion is achieved.

The fourth embodiment may further define the first drying phase to heat and dry the compostable waste material to further include (a) raising the temperature within the bucket and monitoring the humidity within the bucket to adjust the temperature to a final drying phase temperature as the humidity reaches a predetermined range; and (b) grinding the compostable material during the first drying phase.

The fourth embodiment may yet further define the final cooling phase to include (a) shutting off the heating mechanism while grinding the compostable waste material; and (b) shutting off the grinding mechanism when a predetermined cooling off temperature is detected.

The fourth embodiment of the present invention may yet further define the conventional cycle to include a grow cycle. The grow cycle may define (a) a drying phase to heat and dry the compostable waste material; (b) a grinding phase to grind the compostable waste material; and (c) a cooling phase to cool the compostable waste material. The operating parameters during the drying phase, grinding phase and cooling phase can cause pathogens in the compostable waste material to be materially killed but do not cause the microbes in the compostable waste material to be materially killed, such that the output of the grow cycle is broken down compostable waste material that comprises microbes but does not comprise material pathogens.

The present invention may further include a fifth embodiment defined by having a composting device with a housing with a lid and a composting region for receiving compostable waste material. The composting device further defined to have a removable bucket positioned within the housing for receiving the compostable waste material; and an air circulation system includes a fan configured to draw air from a top portion of the bucket into an airflow cover and through a first air filter system and into a second air filter system before the air is vented out of the composting device.

The fifth embodiment may further define the first air filter system to be configured to include a tubular filtration holder positioned above the fan such that the fan draws air through the tubular filtration holder and into an outlet conduit, and the second air filter system to be configured to connect to the outlet conduit and includes a filter box that is positioned adjacent a rear access door. The tubular filtration holder and the filter box are defined to be removable from the composting device but are not disposable as both the tubular filtration holder and the filter box are configured to permit the removal of spent charcoal pellets and the addition of new charcoal pellets. This can further allow for the addition of a scented pellet to either the tubular filtration holder or the filter box.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIGS. 1 and 2 are perspective views of the composting device;

FIG. 3 is a perspective view of the rear of the composting device with the rear access panel door removed;

FIG. 4 is a perspective view of the composting device with the lid in an open position;

FIG. 5 is a perspective view of the composting device with the bucket shown being removed;

FIGS. 6 and 7 are partial exploded views of the housing and internal components of the composting device;

FIG. 8 is an enlarged sectional view of the housing shown attached to the lid;

FIG. 9 is a view of the bucket housing and rim secured to each other;

FIG. 10 is an exploded view of FIG. 9;

FIG. 11 is a perspective view of the bucket housing and component systems;

FIG. 12 is another perspective view of the bucket housing and component systems;

FIG. 13 is a partial exploded view of FIG. 12;

FIG. 14 is a cross sectional view of the bucket and grinding mechanism;

FIG. 15 is an exploded view of the base structure of the composting device;

FIG. 16 is an exploded view of the base of the composting device;

FIG. 17 shows the heating system of the composting device;

FIG. 18 is a system schematic overview of the composting device;

FIGS. 19-23 are schematic overview illustrations of a Bioplastics composting cycle for one embodiment of the present method of invention;

FIGS. 24-27 are schematic overview illustrations of an Eco composting cycle for one embodiment of the present method of invention;

FIGS. 28-31 are schematic overview illustrations of an Express composting cycle for one embodiment of the present method of invention;

FIG. 32 is a perspective view of another composting device in accordance with an embodiment of the invention illustrating the removal of the lid;

FIG. 33 is another perspective view of FIG. 32;

FIG. 34 is a perspective view illustrating the removal of the housing and rear access panel;

FIG. 35 is a further perspective view illustrating the removal of the housing and base from the main components of the composting device;

FIG. 36 is a partial perspective exploded view of the first air filter system;

FIG. 37 is a further exploded view of the first air filter system;

FIG. 38 is a cross section view showing the first air filter system;

FIG. 39 is another sectional view of the composting device showing the air conduit between the first and second air filter systems;

FIG. 40 is another sectional view of the composting device illustrating the second air filter system;

FIG. 41 is a partial cutout sectional view of the composting device illustrating the first and second air filter systems;

FIG. 42 is an exploded view of the first air filter system;

FIG. 43 is a block diagram of the composting device and first and second air filter systems; and

FIG. 44 is a perspective view of a grinder with blades.

### DETAILED DESCRIPTION OF THE DRAWINGS

While the invention is susceptible to embodiments in many different forms, there are shown in the drawings and will be described in detail herein the preferred embodiments of the present invention. It should be understood, however, that the present disclosure is to be considered an exemplification of the principles of the invention and is not intended to limit the spirit or scope of the invention and/or claims of the embodiments illustrated. Various terminology is used herein, such as “compost”, “composting device”, “biopolymer”, “bioplastic” and the like. Except as noted herein, these terms are as defined herein or as known to those of skill in the art and are not necessarily used as defined in any particular legislation, regulations or guidelines.

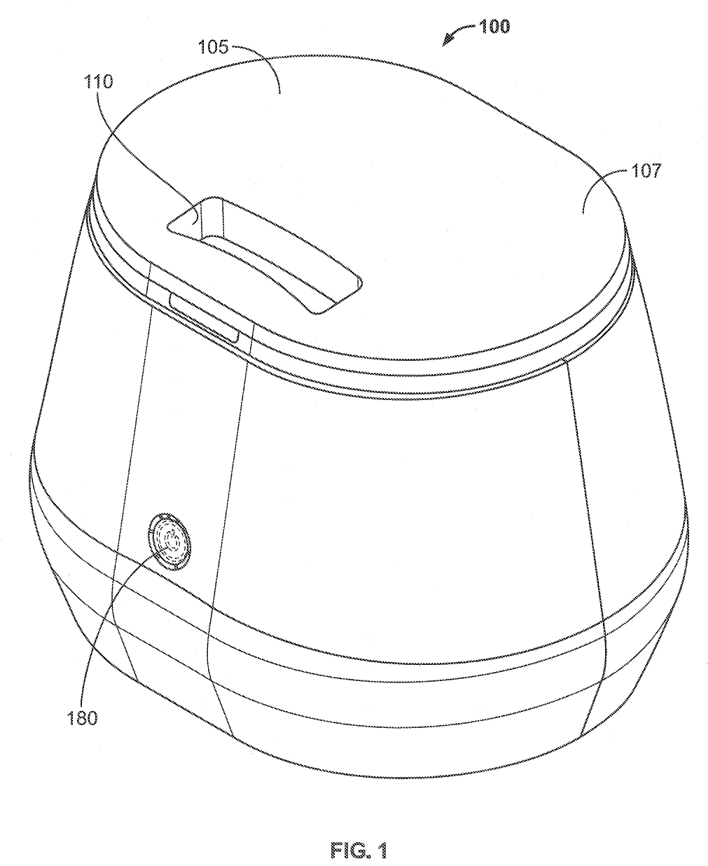

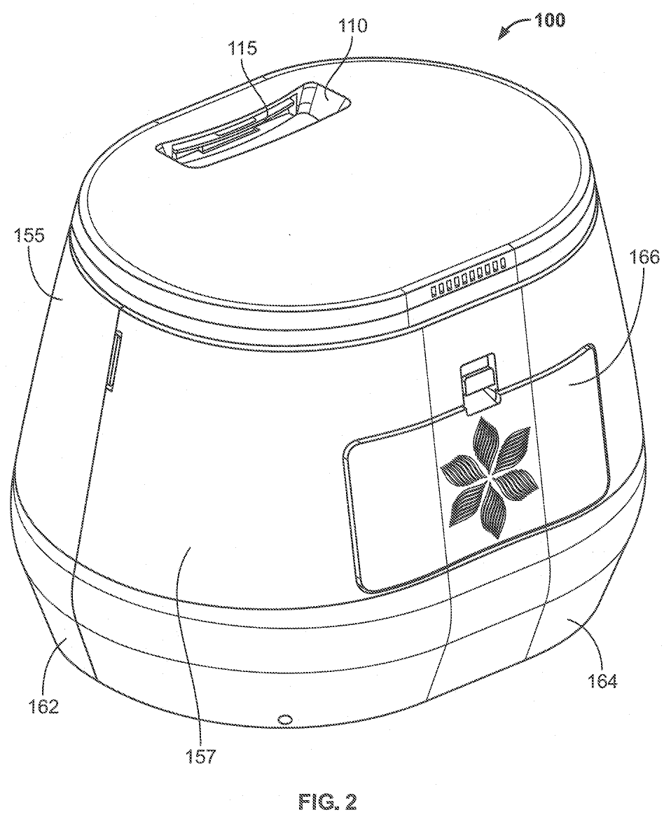

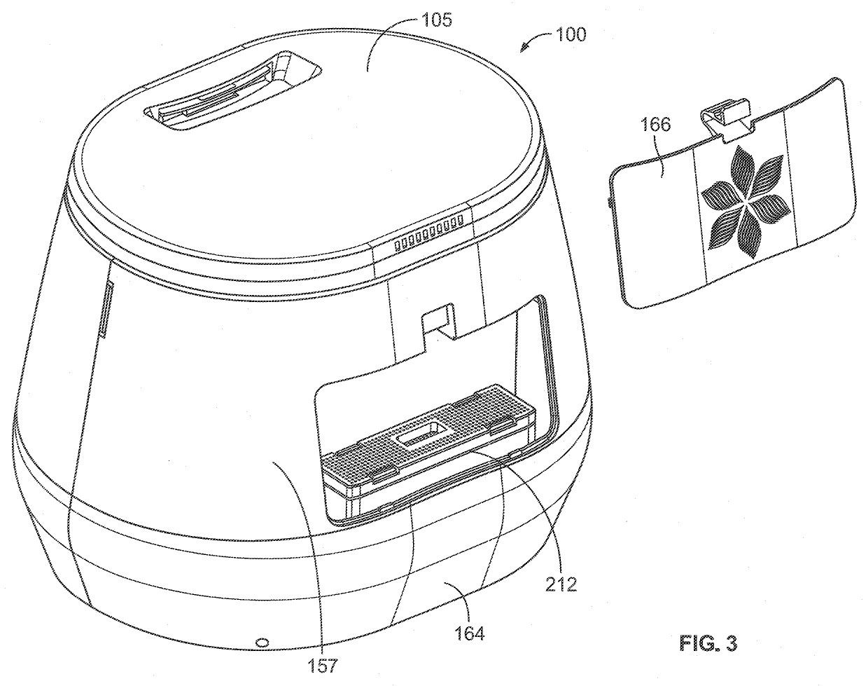

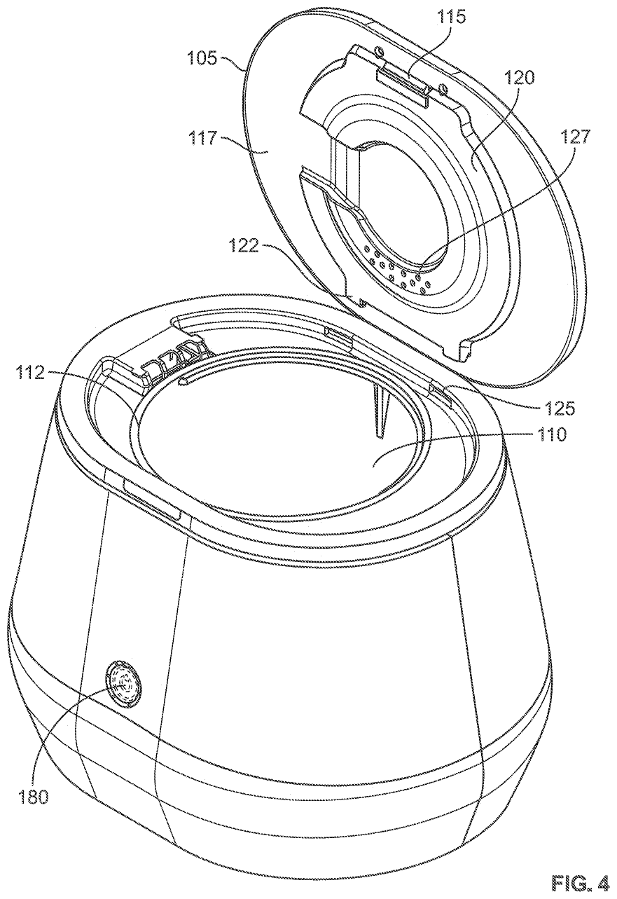

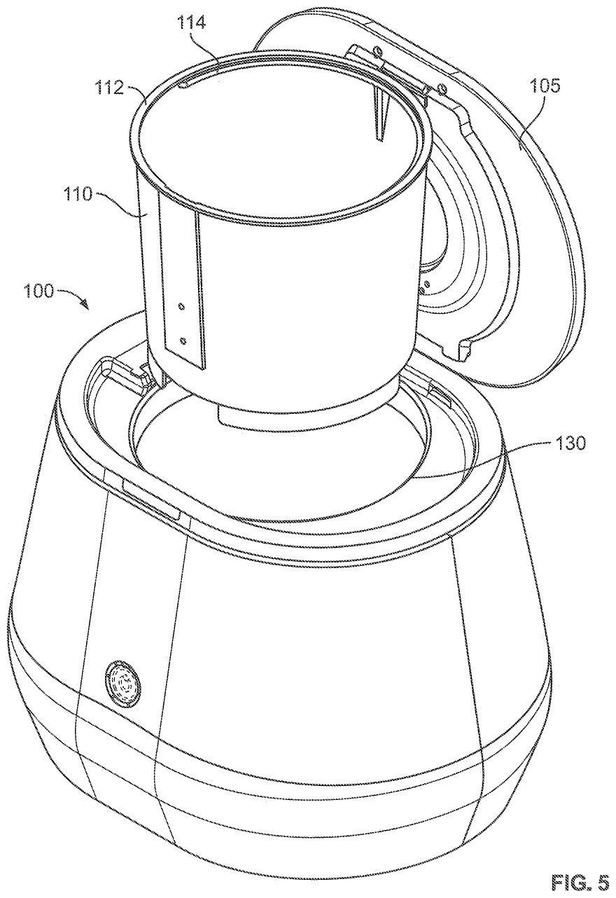

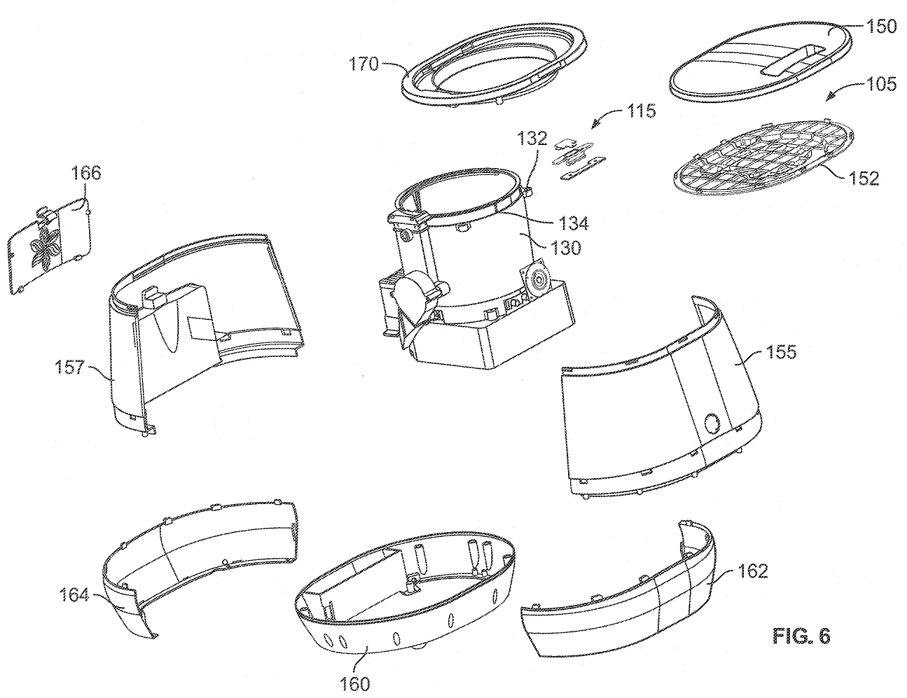

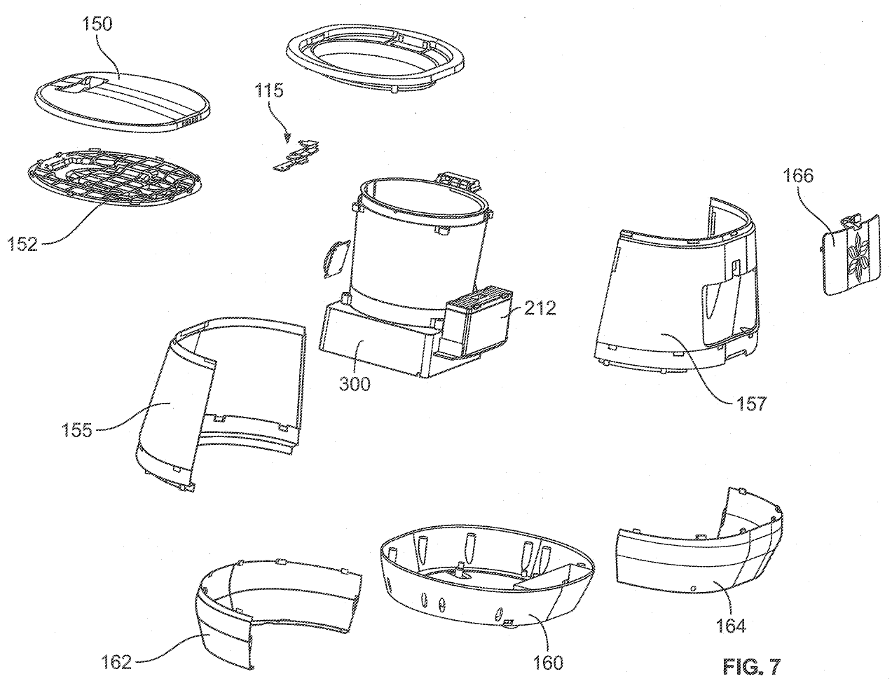

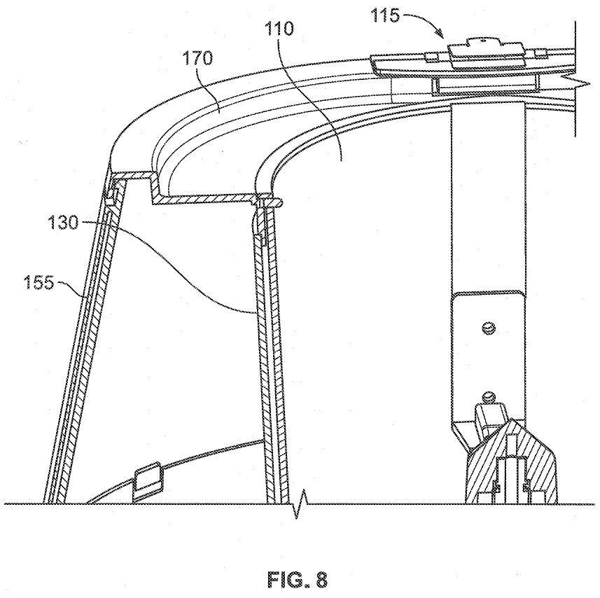

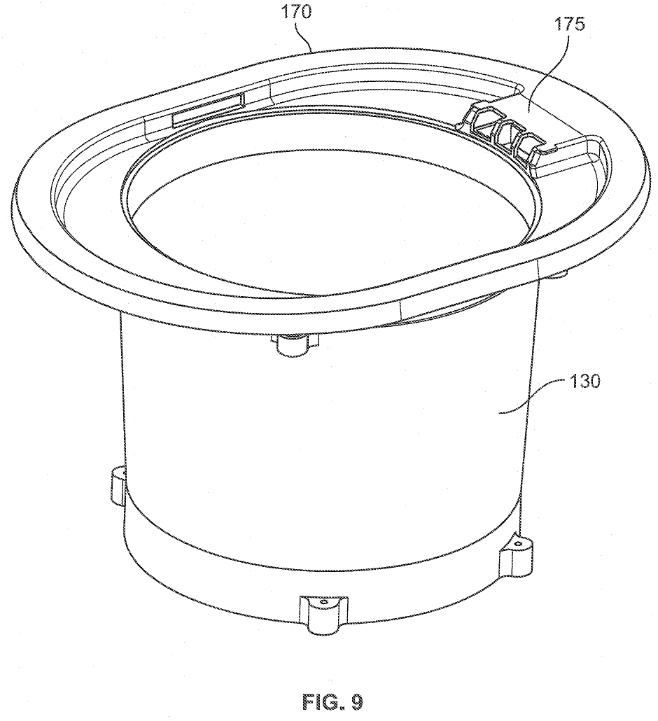

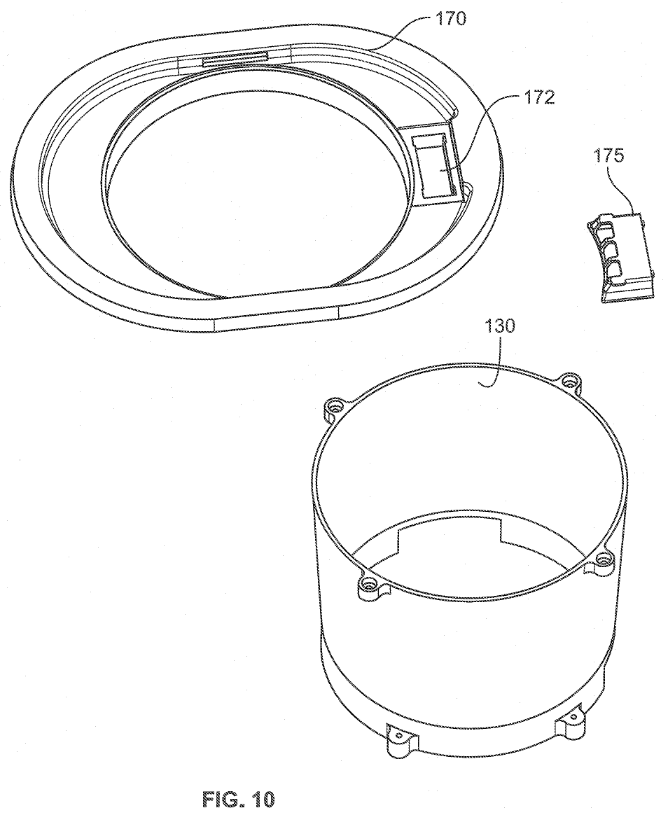

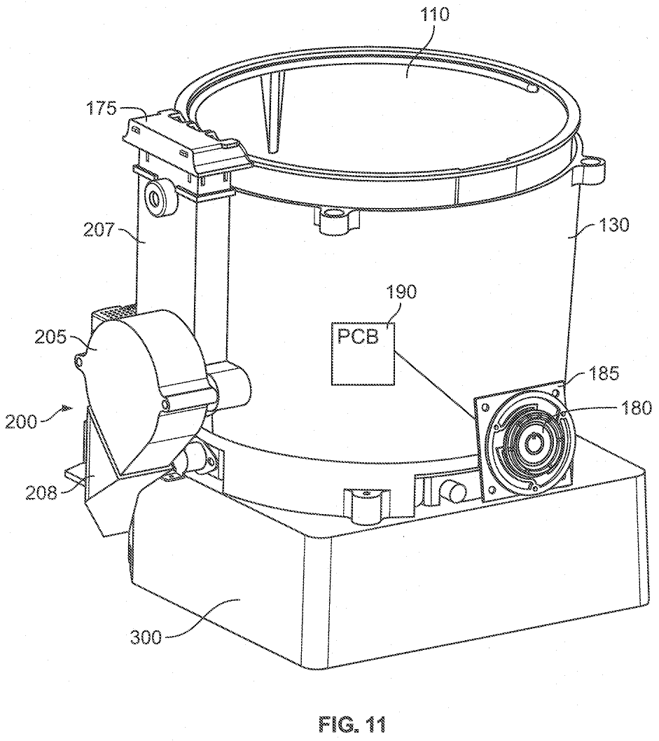

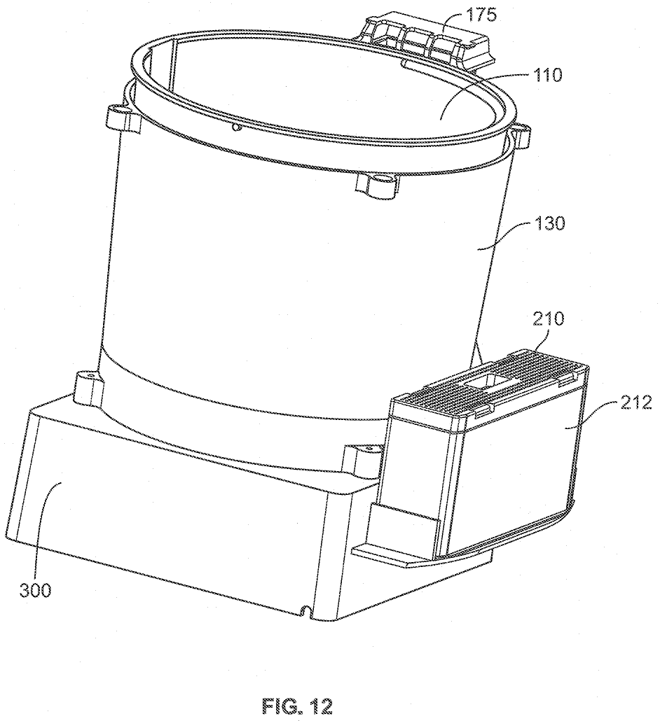

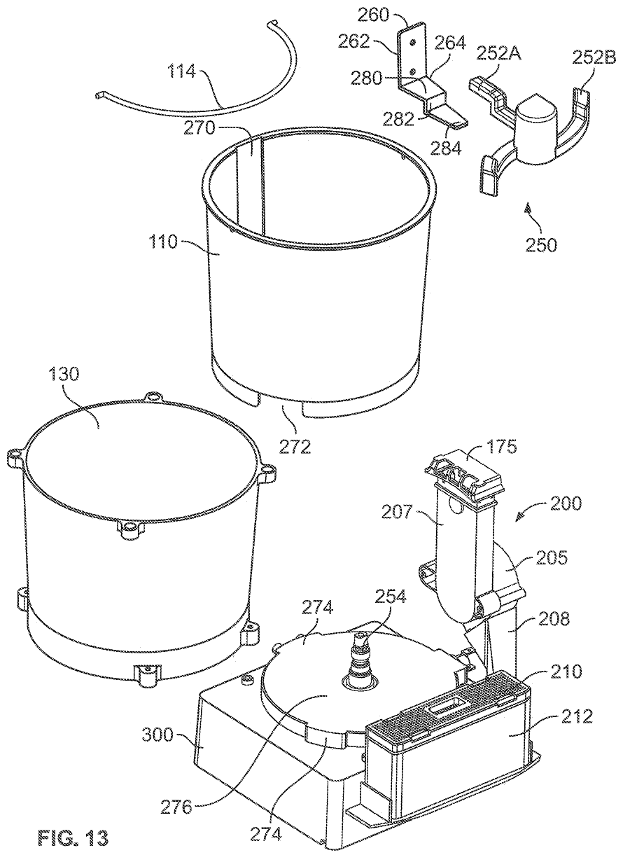

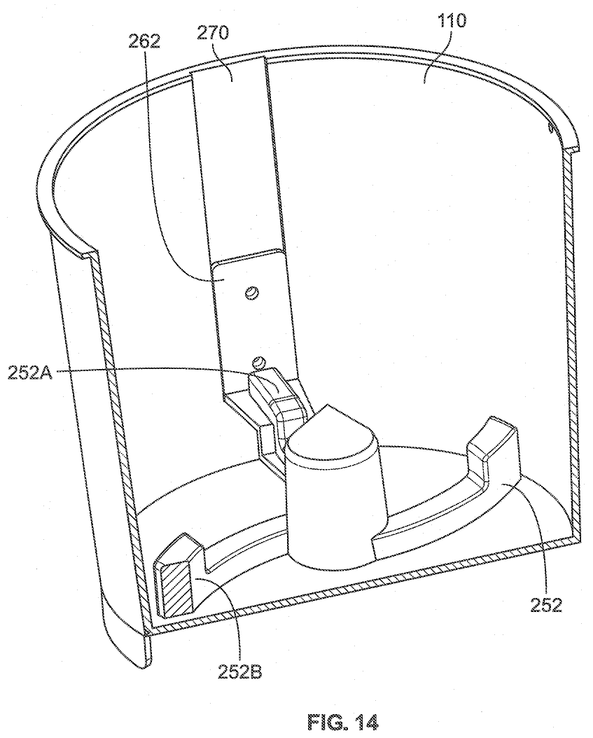

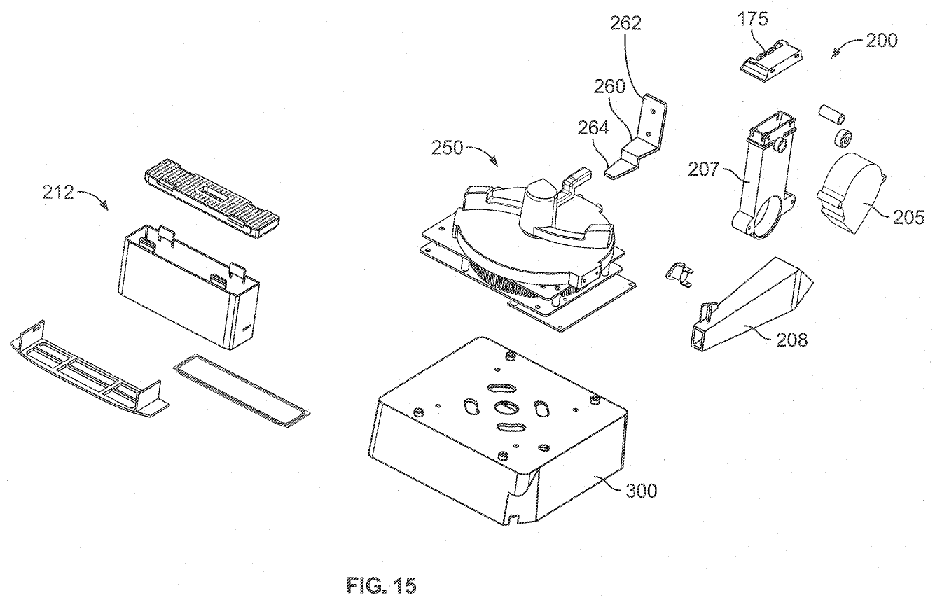

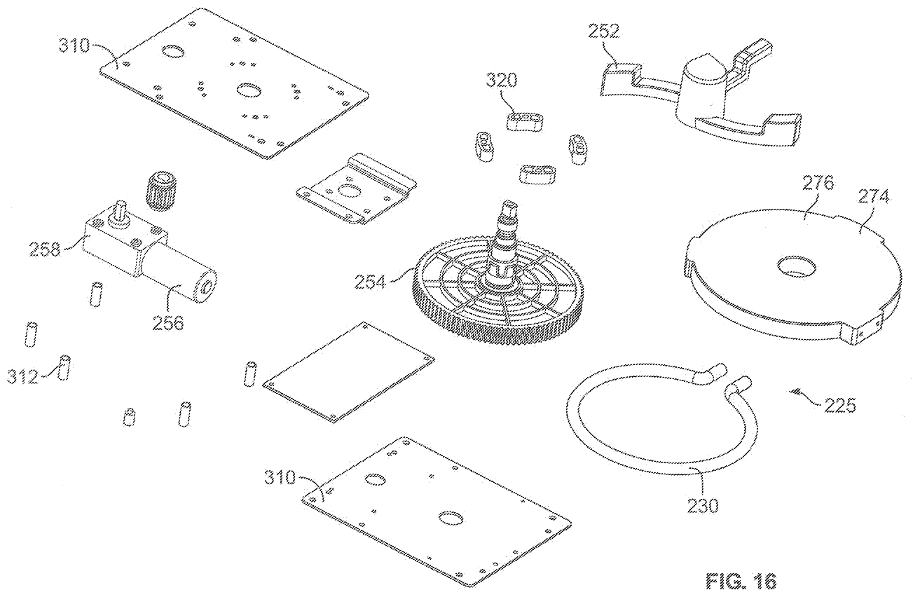

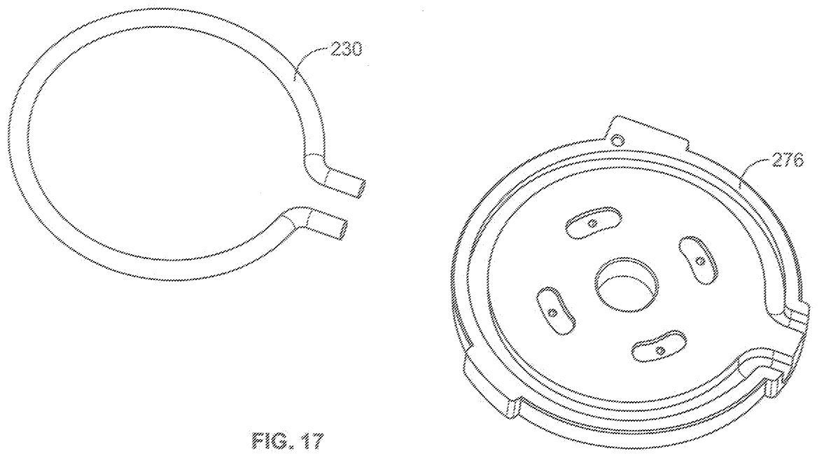

Referring now to FIGS. 1-17, there is shown a Composting Device 100 with a hinged lid 105 and a removable bucket 110. The lid 105 includes a groove region 110 from the top surface 107 that allows the consumer to access and manually open the hinged lock 115 to open the lid 105. The lid 105 further includes a depression seal 120 extending from the inside surface 117. The depression seal 120 rests about the top rim 112 of the bucket 110 and includes a pair of locking feet 122 that hook into recess openings 125 the inside edge of the device 100 when the lid is closed. The depression seal 120 further include vent openings 127 the further assist the venting of the device during use.

The device 100 would plug into a normal electrical outlet and include a dial/activation button 180 that the consumer can use to select the appropriate setting, cycle, or mode. The removable bucket 110 includes a handle 114 for the consumer to easily remove and return the bucket 110 from within a bucket housing 130.

Continuing to refer to the Figures, there is shown the device 100 with a two-piece lid assembly 105 defined by a top lid piece 150 and a lower lid piece 152 that connect to each other as shown in other Figures. The device 100 includes a front panel 155 and a rear panel 157 that secure to each other to house various components (discussed herein below). The front and rear panels connect into a bottom housing 160 with lower front and rear trims, 162 and 164 respectively. In addition, the rear panel 157 includes a rear access door 166 removable by the consumer to allow access to the replaceable charcoal (discussed below).

A top frame 170 is secured to outstanding flanges 132 extending around the periphery of the rim 134 of the bucket housing 130. An inwardly extending hook from the top frame 170 secures to an outwardly extending hook along the top of the front and rear panels to secure the housing in place. The top frame 170 further includes openings 172 along one portion of the edge and includes an airflow cover 175.

While the wiring may be missing from the figures electrical connections are well known and would be easy to implement. The device 100 includes a control panel 185 in communication with the activation button 180. The control panel is in communication with a processor 190 to control the various housing systems and run the device. The various housing systems include an air circulation system 200, a heating mechanism 225, and grinding mechanism 250. In addition, the user does not need to add water to the system.

The air circulation system 200 includes a fan 205 drawing air from the bucket through the airflow cover 175 into an air inlet conduit 207 through the fan 205 and out an outlet conduit 208 into an outflow air filter 210. The outflow air filter 210 includes a filter housing 212 positioned adjacent to the rear access door 166. Air is filtered and flows out of the filter box. The outflow air filter 210 is a reusable cartridge that can be pulled out of the device, and refilled with activated charcoal pellets, which provides the filtration. This is unique to the device, since there is no plastic waste involved in replacing the filter. Other existing devices work with disposable plastic filters causing additional waste which is counter intuitive to a device designed to compost waste.

The grinding mechanism 250 includes multiple grinding blades 252 rotated by a gear 254 that is driven by a motor 256 and gearbox 258. The grinding mechanism 250 further includes an L shaped plate 260 defined to have an arm 262 positioned and secured along a groove 270 in the bucket 110. The L shaped plate 260 further includes a leg 264 extending towards the center of the bucket and has an upper leg section 280 and downward extension 282 and a lower leg section 284. The blades 252 are configured such that when rotating one or more of the blades 252A travel over the upper leg section 280, while the remaining blades 252B travel under the upper leg section 280. The movement of the blades 252 over and under the upper leg section, helps grind the waste in the bucket.

The bucket 130 includes notches 272 positioned on the bottom of the bucket 130 and which sit into protruding edges 274 on a base plate 276.

In addition, the user may be able to add liquid bio-additives to assist in the composting cycles. While not required it could help with the composting of the waste and degradable materials. The composition of the additives may include organic matter such as sawdust, amino acids, cellulose, wood powder, activated carbon, bacillus, talc, rice hull, lipase, biochar, microbes, and other fillers. While water is not needed to run the system, water may be used in the liquid bio-additives as a filler.

The bucket housing 130 which has a hollow bottom is secured onto a pedestal 300 around the base plate 276. The pedestal 300 is secured to the bottom housing 160 with various components secured under the pedestal 300. The components include the motor and gearbox, and a pair of plates 310 with connectors 312 connecting the plates 310 together. The plates 310 are positioned on either side of the pinions on the gear 254. Manifold spacers 320 are also provided and connect underneath the bucket housing to the pedestal 300 through the top plate 310 to help ensure the bucket housing is secured and may help reduce vibration.

The heating mechanism 225 is composed of the base plate 276 and a heating element 230. When activated the heating element 230 heats the entire base plate 276 which heats the base of the bucket 110.

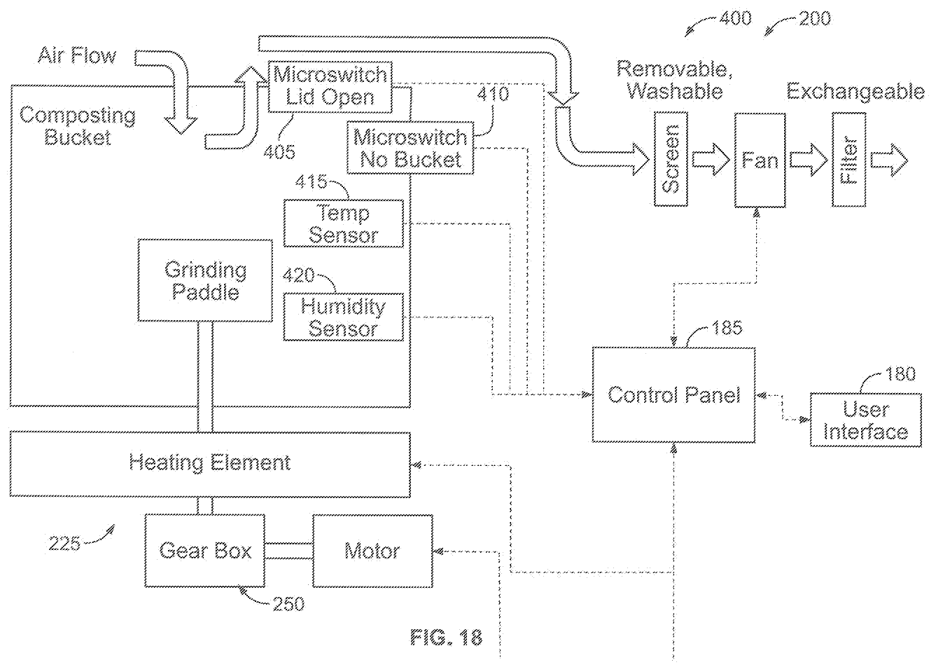

Referring to FIG. 18, there is shown a system schematic overview that outlines the connection of the components to the overall operation of the system 400. The system includes additional safety features including a microswitch 405 to indicate if the lid is open and a microswitch 410 to indicate if the bucket is removed. Additional sensors (temp sensor 415 and humidity sensor 420) are provided to help further control the system 400.

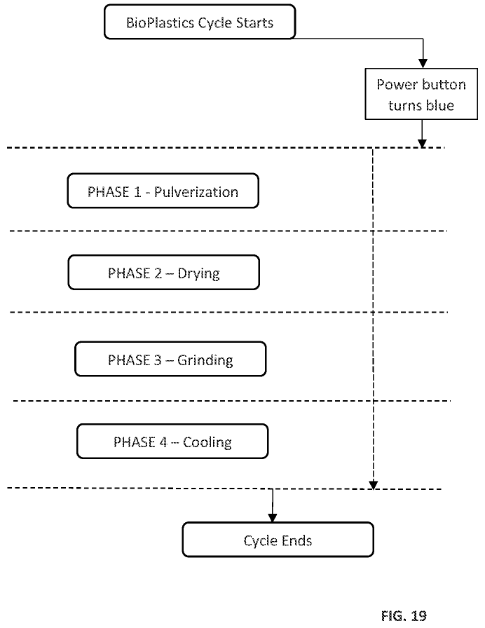

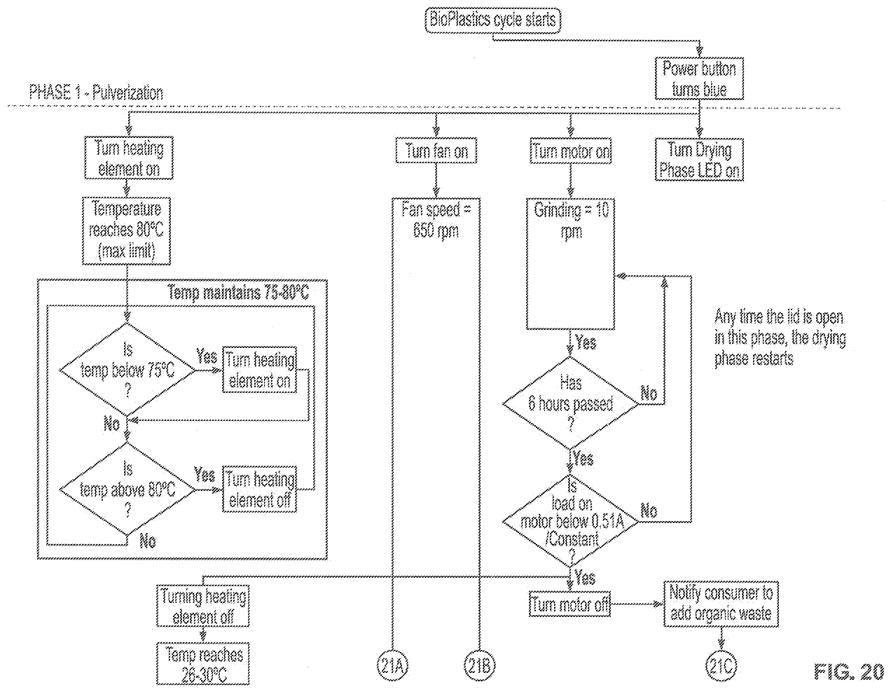

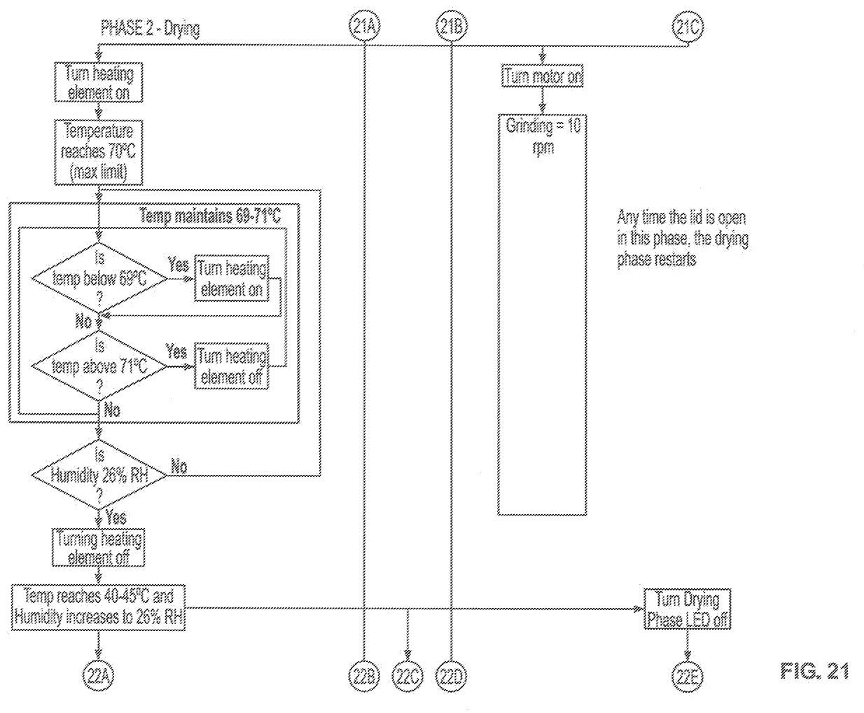

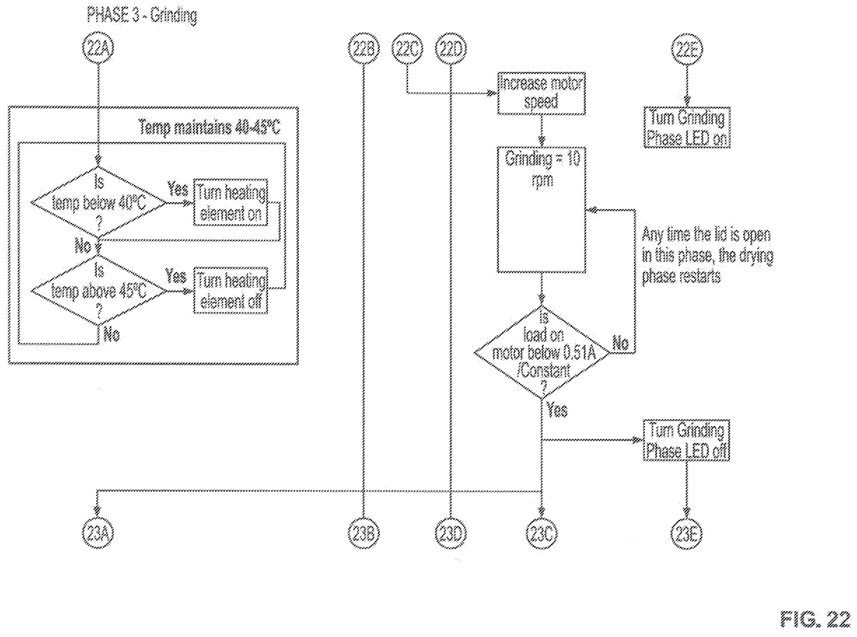

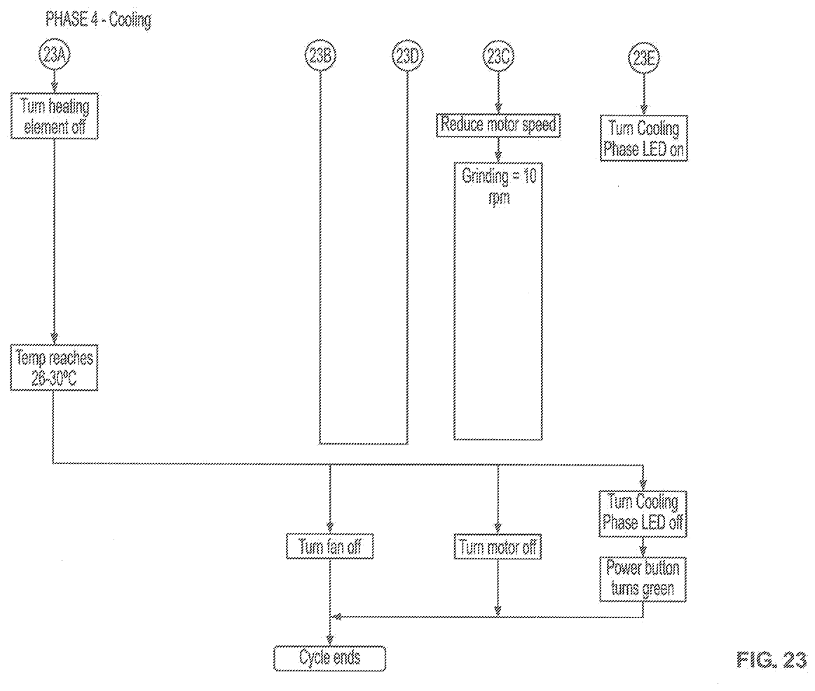

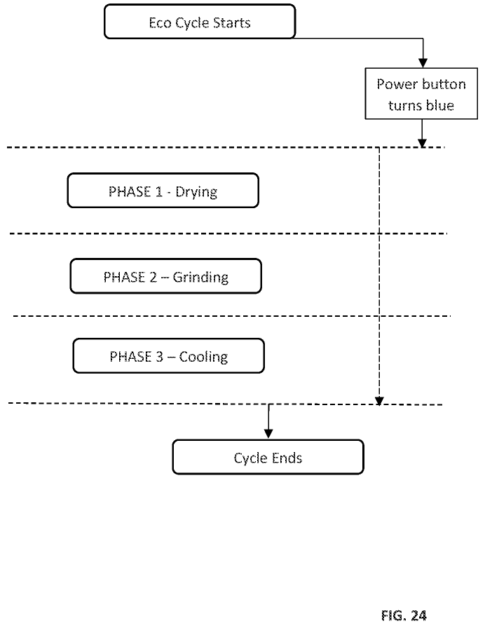

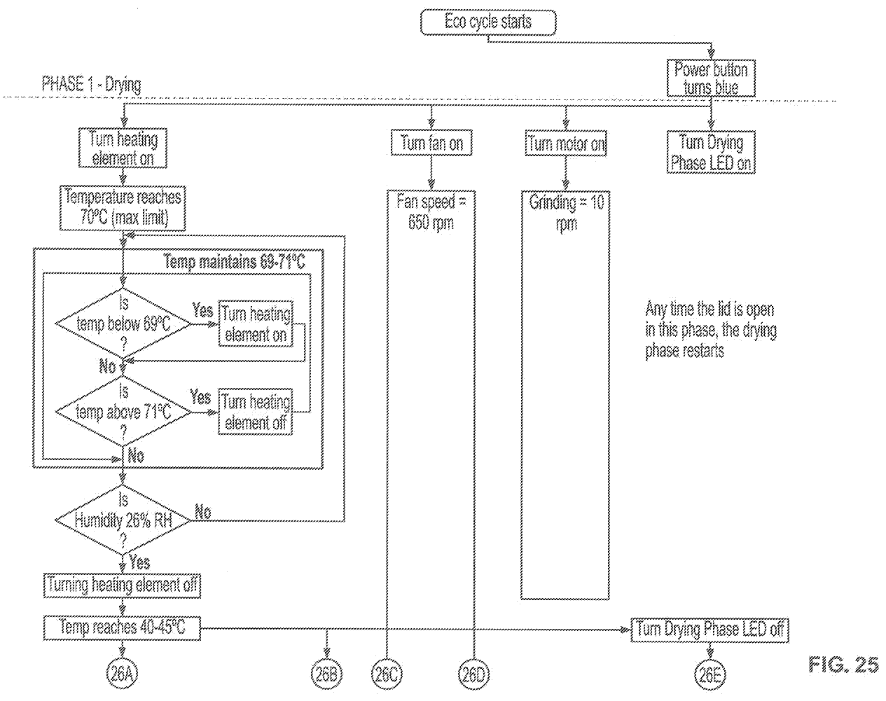

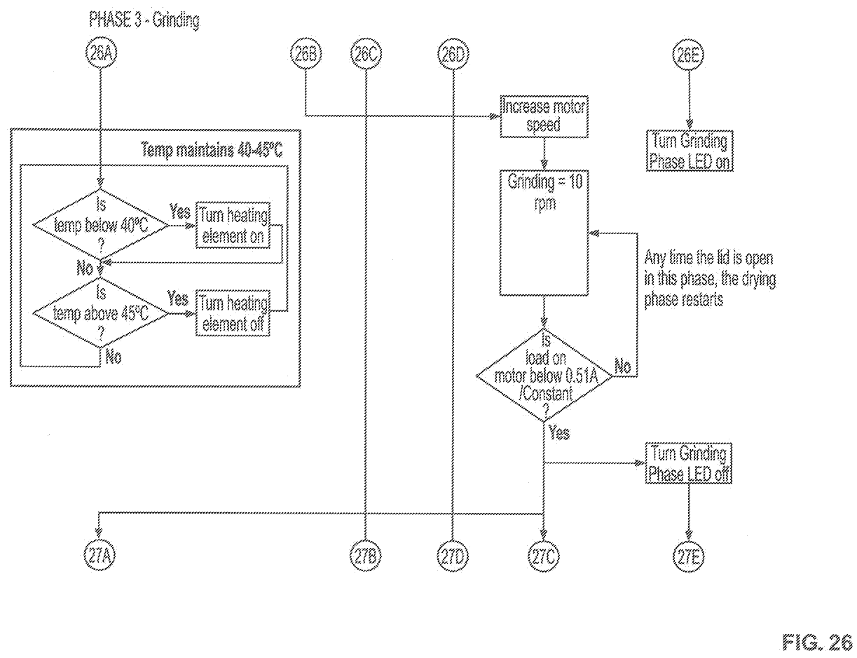

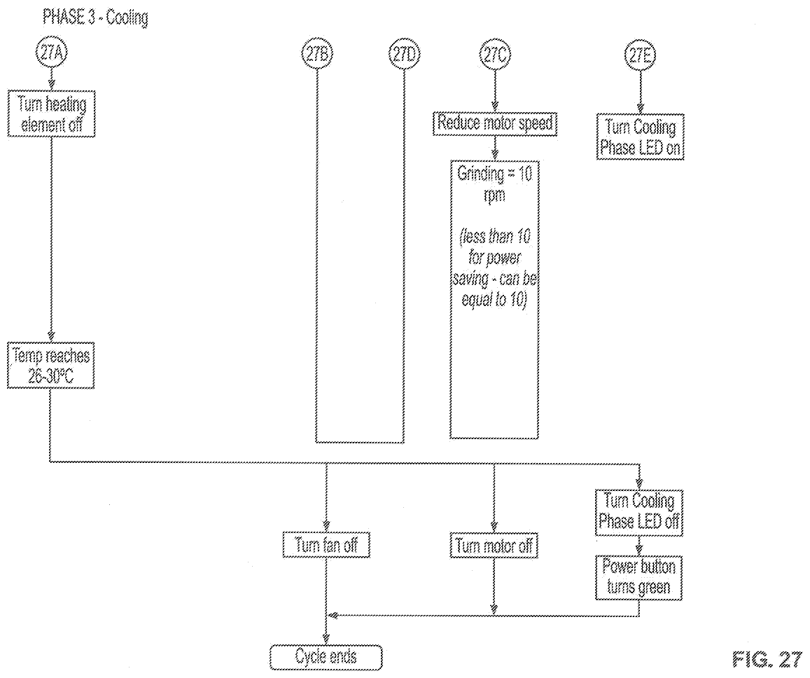

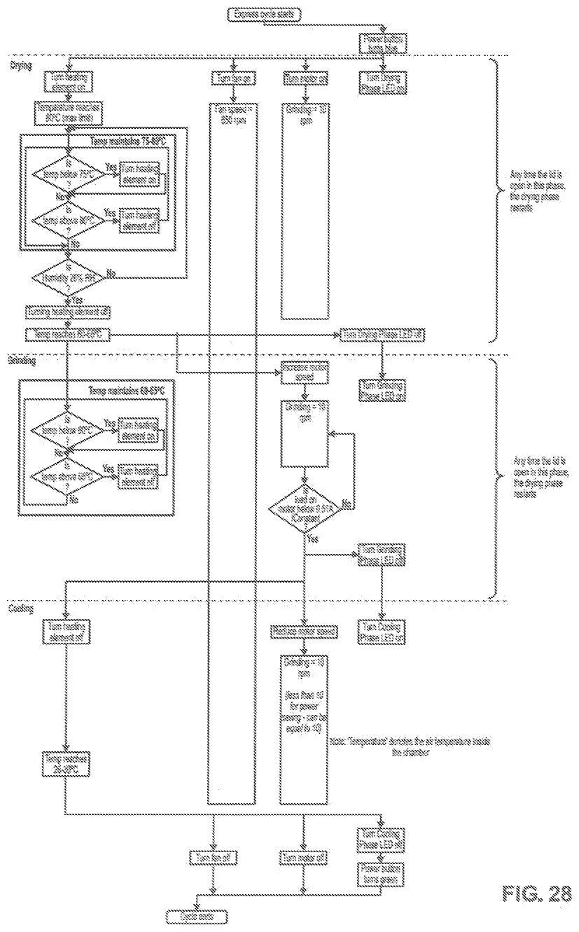

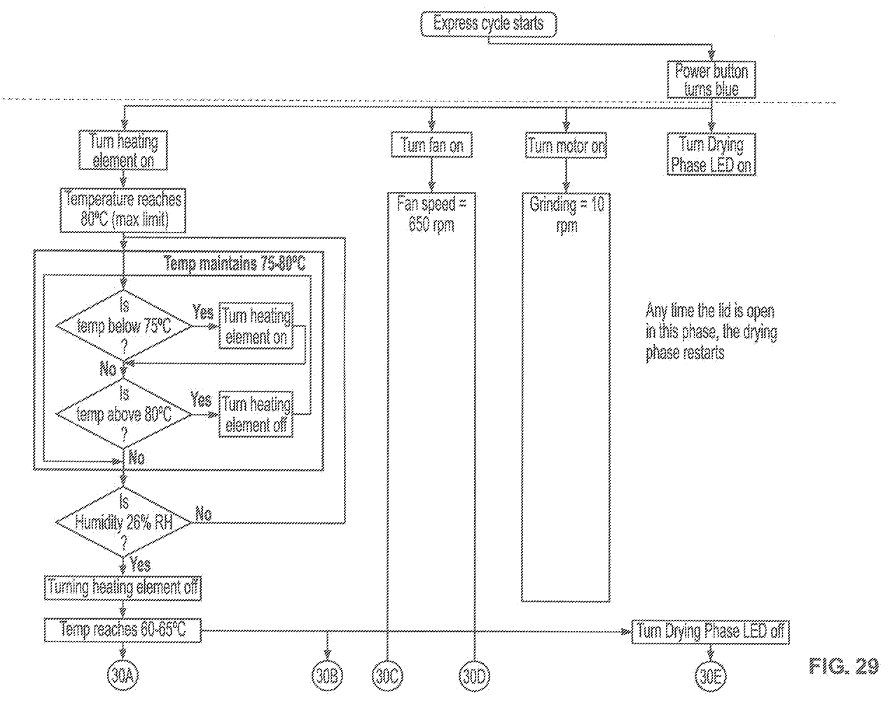

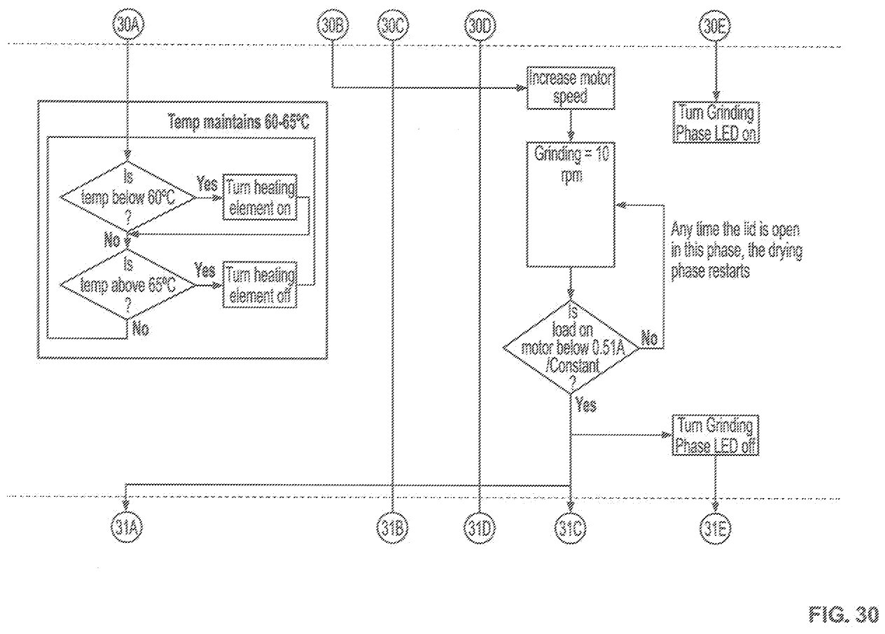

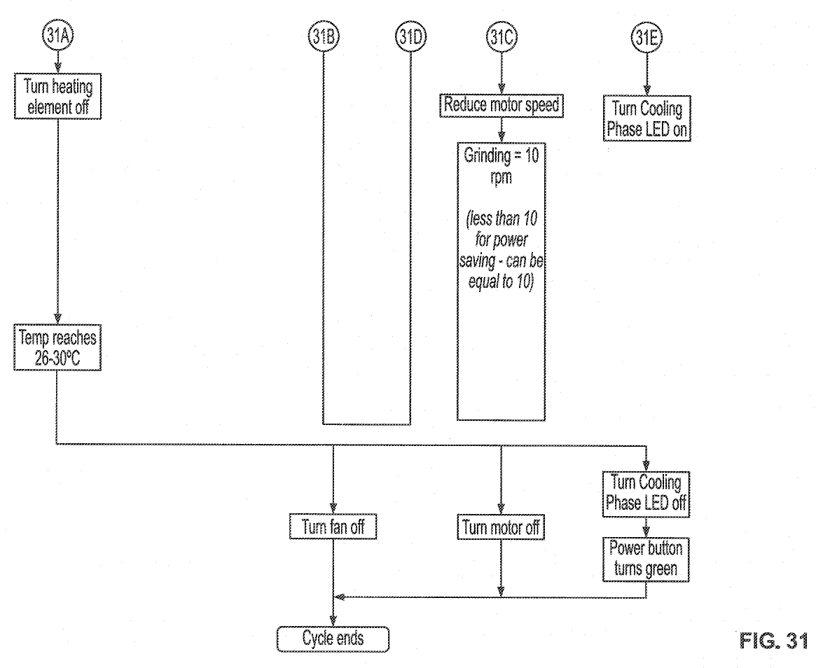

The system is also designed to have various run cycles from a set of composting cycles. FIGS. 19-23 outline a Bioplastics cycle (also known as “bioplastics approved cycle” or “Lomi™ approved cycle”); FIGS. 24-27 outline an Eco cycle (also known as “grow cycle”), and FIGS. 28-31 outline an Express cycle (also known as “ecoexpress cycle”). The grow cycle and the ecocycle may each be exemplary “conventional cycles”—not particularly directed to or suitable for bioplastics or browns.

Continuing to refer to FIGS. 19-23 the Bioplastics Cycle is shown. The Lomi™ approved cycle is primarily for breaking down compostable waste material that includes at least some biopolymers (such as Lomi approved biopolymers that have been tested to ensure suitable breaking down via a composting device) and/or “browns”—natural fibre products. Such cycle may adjust operating parameters to provide for additional grinding for bioplastic, more grinding activity, higher temp—longer cycle, that may be conducive to more effective breaking down of biopolymers and browns.

Abbreviations

| | Short | | |
|---|---|---|---|
| Cycle | Form | Operating Parameter | Operating Parameter Range |
| BIOPLASTIC | XF1 | Fan rpm value | 500-750 RPM, preferably |
| | | | approximately 650 RPM |
| | XG1 | Grinder rpm value | 2-25 rpm and preferably |
| | | | approximately 10 rpm |
| | XE1 | Electric motor load value | 0.5-0.7 A Current and |
| | | | preferably approximately 0.51 A |
| | XH1 | Humidity value | 20%-40% RH and |
| | | | preferably approximately 26% |
| | XH2 | Humidity value | 20%-40% RH |
| | XG2 | Grinder rpm value | 1-10 rpm and preferably |
| | | | approximately 10 rpm |
| | XG3 | Grinder rpm value | 2-25 rpm and preferably |
| | | | approximately 10 rpm |
| | XE2 | Electric motor load value | 0.5-0.7 A load current and |
| | | | preferably approximately 0.51 A |
| | XG4 | Grinder rpm value | 2-25 rpm and preferably |
| | | | approximately 10 rpm |

The program may set the system to a four-phase cycle or a three-phase cycle.

Phase One: Pulverization (Optional)
Indicator led shows Drying cycle
Duration
   When load (amplitude) on motor falls below X_{E1} stays constant/at least 6 hours (exemplary phase end triggers)
Temperature (Performance variable):
   Temperature ramps to, for example, 80° C. (highest) as the cycle starts.
Grinder:
   X_{G1} rpm throughout this phase
After load (amplitude) on motor falls below X_{E1} stays constant/at least after 6 hours, for example, pulverization phase finishes (further exemplary phase end triggers).
No heating/only cooling down after this until temperature reaches, for example, 28° C.±2° C. Phase completes at this temperature.
Flashing LED in both the drying and power button to tell the consumer to put in organic waste, though a mix of biopolymer and organic/food waste may be added initially, and this step may be optional in any event
Anytime the Lid is opened in this phase, the pulverization phase restarts (temperature ramping to, for example, 80° C.) (an exemplary phase start trigger)
Grinder jam notification anytime the motor overloads
This phase may be used, particularly if the household waste is more biopolymer than food matter, but is optional
The addition of additives may assist in the breaking down process, though having a mixture of food waste may at least partially replace additives

Phase Two: Drying
Program LED shows drying and grinding cycle
Duration
   Would depend upon the moisture content and the amount of the waste (which may be as determined by a moisture sensor 420 and one or more sensors for remaining compostable waste material—both of which being exemplary cycle end triggers)
Temperature and Humidity (Performance variables):
   Temperature ramps to, for example, 70° C. (highest) as the cycle starts until the humidity reaches X_{H1}%.
   As humidity reaches X_{H1}% relative humidity, temperature falls to and maintained at, for example, 45-50° C.
   Humidity at, for example, 45-50° C. also increases to X_{H2}% relative humidity
Grinder:
   X_{G2} rpm throughout this phase
Anytime the Lid is opened in this phase, the drying phase restarts (temperature ramping to, for example, 70° C.)
Grinder jam notification anytime the motor overloads.

Phase Three: Grinding
Cycle LED shows drying and grinding cycle.
Duration:
   Might be the largest phase of the cycle
Temperature and Humidity:
   Temperature maintained at, for example, 45° C. during this phase. Remains constant throughout the phase
   Humidity remains constant at X_{H2}% relative humidity
Grinder:
   X_{G3} rpm
When load (amplitude) on motor falls below X_{E2}, grinding phase completes (an exemplary phase end trigger), followed by cooling phase
When load (amplitude) on a motor indicates a jam, the motor may be paused for a period of time (for example 15 seconds) and the motor then runs in reverse. This approach, of turning the motor in one direction, pausing, and then turning it in the opposite direction, may be used throughout the grinding phase, in any cycle
Anytime the Lid is opened in this phase, the drying phase restarts (temperature ramping to, for example, 70° C.).

Phase Four: Cooling
Cycle LED shows Cooling cycle
Duration:
   Shortest phase of the cycle
Temperature and Humidity:
   No heating with continuous grinding until a temperature of, for example, 28±2° C.is achieved
   Phase complete when temperature reaches, for example, 28±2° C.
Grinder: X_{G4} rpm
   Cycle complete.
The contents of the composting device may be removed after the cycle is complete (for this and any other cycle) or may be left in, for example if there is still enough space left in bucket 110. This may leave additives and nutrients that might help break down material in the next cycle.

Continuing to refer to FIGS. 24-27 the Eco Cycle, or grow cycle, is shown. The grow cycle is primarily for compostable waste material that does not include biopolymers or “browns”, and where the output of the composting device may be used in gardens, for growing further food. Such cycles may adjust operating parameters to provide for less energy, fertile compost as output (microbially activated) and a longer cycle. Grow cycle operating parameters may further be chosen and allow for pathogens to be killed while allowing microbes to survive.

Abbreviations

| | Short | | |
|---|---|---|---|
| Cycle | Form | Operating Parameter | Operating Parameter Range |
| ECO | XF1 | Fan rpm value | 500-750 RPM and preferably |
| | | | approximately 650 rpm |
| | XG1 | Grinder rpm value | about 5-25 rpm and preferably |
| | | | approximately 10 rpm |
| | XH1 | Humidity value | 15-35% RH and preferably |
| | | | approximately 26% |
| | XG2 | Grinder rpm value | about 5-25 rpm and preferably |
| | | | approximately 10 rpm |
| | XE1 | Electric motor load value | 0.4-0.7 A load current and |
| | | | preferably approximately 0.51 A |

The program sets the system to a three-phase cycle.

Phase One: Drying
Cycle LED shows drying and grinding cycle
Duration
   May be the second longest phase of the whole cycle
   Would depend upon the moisture content and the amount of the waste (which may be as determined by a moisture sensor 420 and one or more sensors for remaining compostable waste material—both of which being exemplary cycle end triggers)
Temperature and Humidity (Performance variables):
   Temperature ramps to, for example, 70° C. (highest) as the cycle starts until the humidity reaches X_{H1}%.
   As humidity is maintained at X_{H1}%, temperature falls to and maintained at, for example, 40-45° C.
   Humidity then increases to X_{H2}% relative humidity at, for example, 40-45° C.
Grinder:
   X_{G1} rpm throughout this phase
Anytime the Lid is opened in this phase, the drying phase restarts (temperature ramping to, for example, 70° C.)
Grinder jam notification anytime the motor overloads

Phase Two: Grinding
Cycle LED shows drying and grinding cycle
Duration:
   Might be the largest phase of the cycle
Temperature and Humidity:
   Temperature maintained at 40° C. during this phase. Remains constant throughout the phase.
   Humidity remains constant at X_{H2}% relative humidity
Grinder:
   X_{G2} rpm
When load (amplitude) on motor falls below X_{E1}/becomes constant, grinding phase completes followed by cooling phase
Anytime the lid is opened in this phase, the drying phase restarts (temperature ramping to, for example, 70° C.)

Phase Three: Cooling
Indicator LED shows Cooling
Duration:
   Shortest phase of the cycle
Temperature and Humidity:
   No heating and continuous grinding until the chamber air temperature is, for example, 28±2° C.
   Humidity may be close to the ambient relative humidity at the end of this phase
   Phase complete when temperature reaches, for example, room temperature/28±2° C.
Grinder: X_{G3} rpm

### Cycle Complete

Continuing to refer to FIGS. 28-31 the Express Cycle, or ecoexpress cycle, is shown. The ecoexpress cycle is also primarily for compostable waste material that does not include biopolymers, but where the output of the composting device is not as likely to be used in gardens. Such cycles may adjust operating parameters to provide for more grinding activity, optionally higher temperature and a shorter cycle with a dehydrator mode (optionally at the highest temperature, which may result in greatest volume reduction). As used in the cycle schematic:

Abbreviations

| | Short | | |
|---|---|---|---|
| Cycle | Form | Operating Parameter | Operating Parameter Range |
| EXPRESS | XF1 | Fan rpm value | 500-750 PM and preferably |
| | | | approximately 650 rpm |
| | XG1 | Grinder rpm value | about 5-25 rpm and preferably |
| | | | approximately 10 rpm |
| | XH1 | Humidity value | 20-40% RH and preferably |
| | | | approximately 26% |
| | XG2 | Grinder rpm value | about 5-25 rpm and preferably |
| | | | approximately 10 rpm |
| | XE1 | Electric motor load value | 0.4-0.7 A load current and |
| | | | preferably approximately 0.51 A |
| | XG3 | Grinder rpm value | about 5-25 rpm and preferably |
| | | | approximately 10 rpm |

The program sets the system to a three-phase cycle.

Phase One: Drying
Cycle LED shows drying and grinding cycle
Duration:
   May be the second longest phase of the whole cycle
   Would depend upon the moisture content and the amount of the waste (which may be as determined by a moisture sensor 420 and one or more sensors for remaining compostable waste material—both of which being exemplary cycle end triggers)
Temperature and Humidity (Performance variables):
   Temperature ramps to, for example, 75-80° C. (highest) as the cycle starts until the humidity reaches X_{H1}%.
   As humidity is maintained at X_{H1}%, temperature falls to and maintained at, for example, 60-65° C. Humidity then increases to X_{H2}% relative humidity at 60-65° C.
Grinder:
   X_{G1} rpm throughout this phase
Anytime the lid is opened in this phase, the drying phase restarts (temperature ramping to, for example, 75-80° C.).
Grinder jam notification anytime the motor overloads

Phase Two: Grinding
Cycle LED shows drying and grinding cycle
Duration:
   Might be the largest phase of the cycle
Temperature and Humidity:
   Temperature maintained at, for example, 40° C. during this phase. Remains constant throughout the phase.
   Humidity remains constant at X_{H2}% relative humidity
Grinder:
   X_{G2} rpm
When load (amplitude) on motor falls below X_{E1}/becomes constant, grinding phase completes followed by cooling phase
Anytime the lid is opened in this phase, the drying phase restarts (temperature ramping to, for example, 75-80° C.)

Phase Three: Cooling
Cycle LED shows Cooling
Duration:
   Shortest phase of the cycle
Temperature and Humidity:
   No heating and continuous grinding until the chamber air temperature is, for example, 28±2° C.
   Humidity may be close to the ambient relative humidity at the end of this phase
   Phase complete when temperature reaches, for example, room temperature/28±2° C.
Grinder: X_{G3} rpm
   Cycle complete

Three cycles (“grow”, “ecoexpress” and “Lomi™ approved”) and three or four phases (pulverization, drying, grinding and cooling) have been described herein. Each cycle may have one or more central purposes and features, as described. Each phase may be adjusted, using one or more of the operating parameters (such as temperature, RPM, humidity and the like) and one or more phase end triggers and phase start triggers, to be appropriate for the cycle selected. The cycles and phases may be monitored, either manually or automatically, for example via operating parameters. Although described distinctly, phases may overlap, for example with drying occurring as grinding is occurring. While in one embodiment the composting device output (compostable waste material after it has been run through at least part of one cycle as described herein) may be removed after one cycle, it may also be left in for a further cycle—particularly if the then current output is likely to assist in the breaking down of compostable waste material for a subsequent cycle and the bucket 110 is not too full. It is further to be understood that the order, number and operating parameters for the phases in each cycle are exemplary only and may be varied to achieve the desired effect on the compostable waste material.

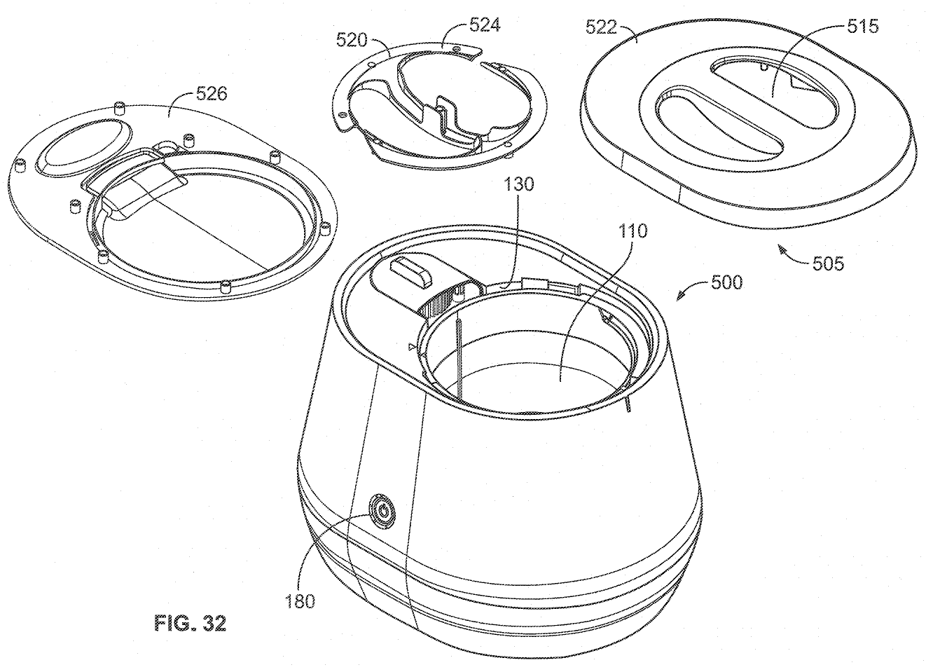

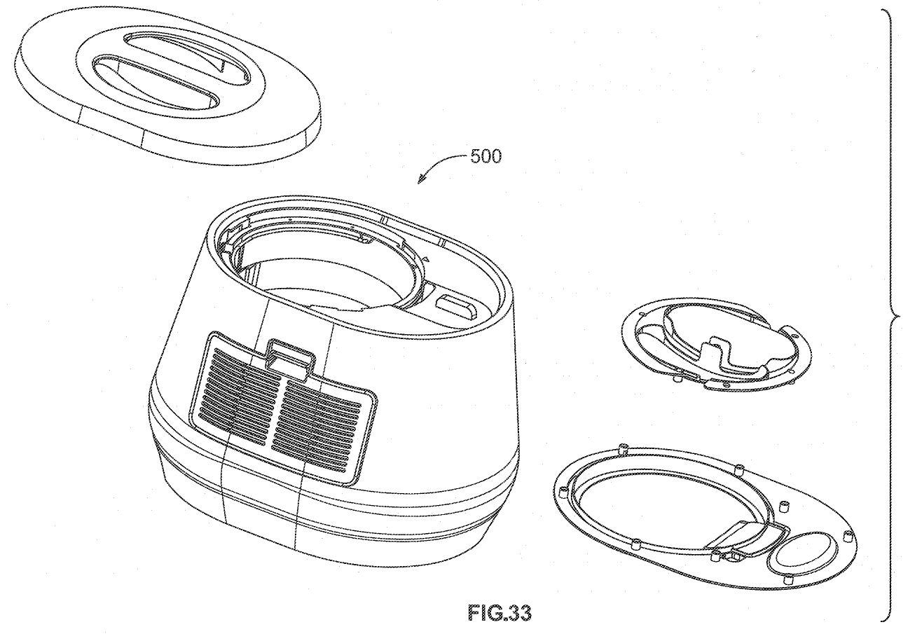

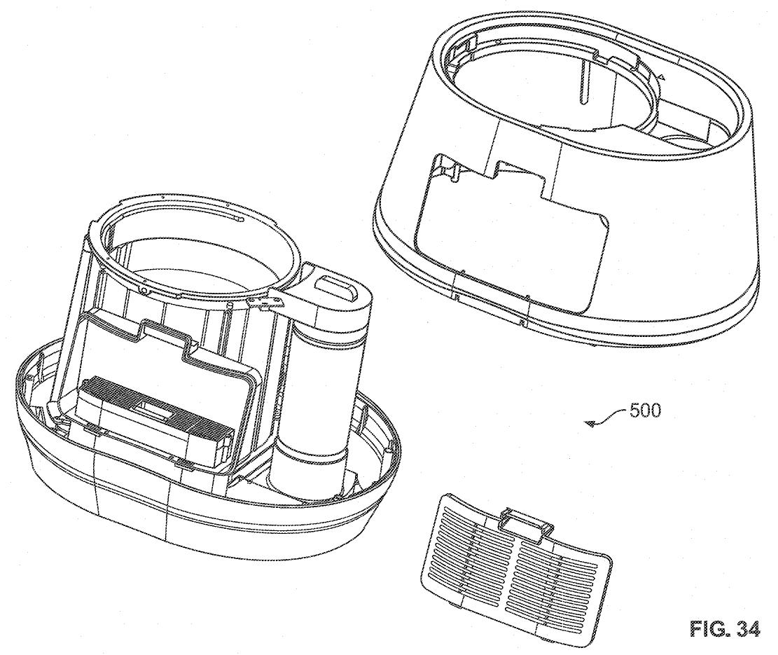

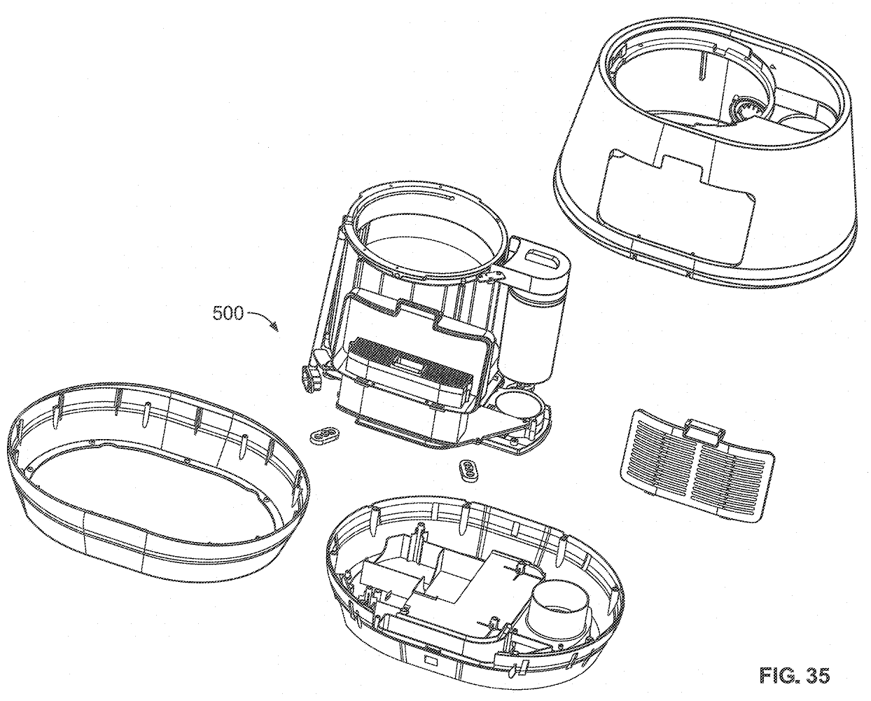

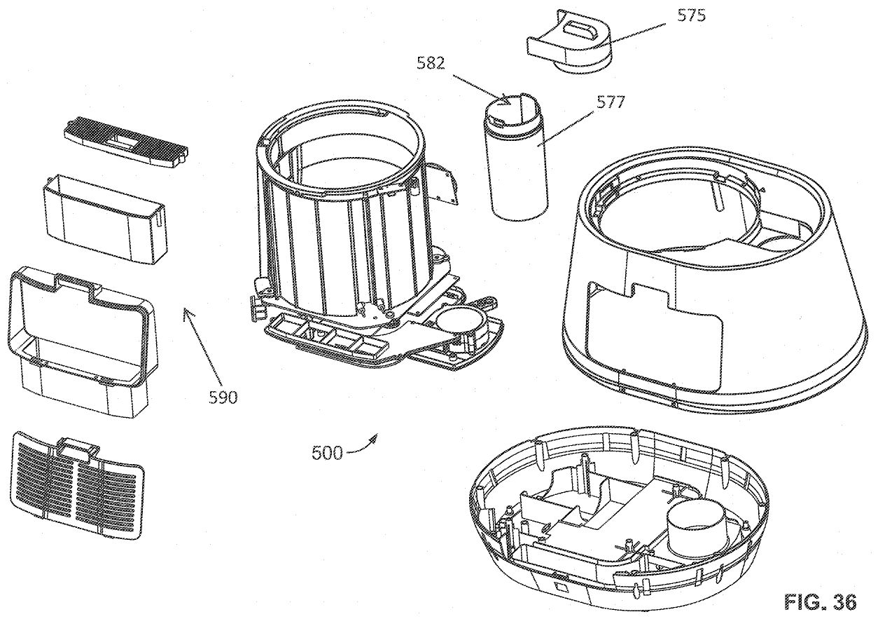

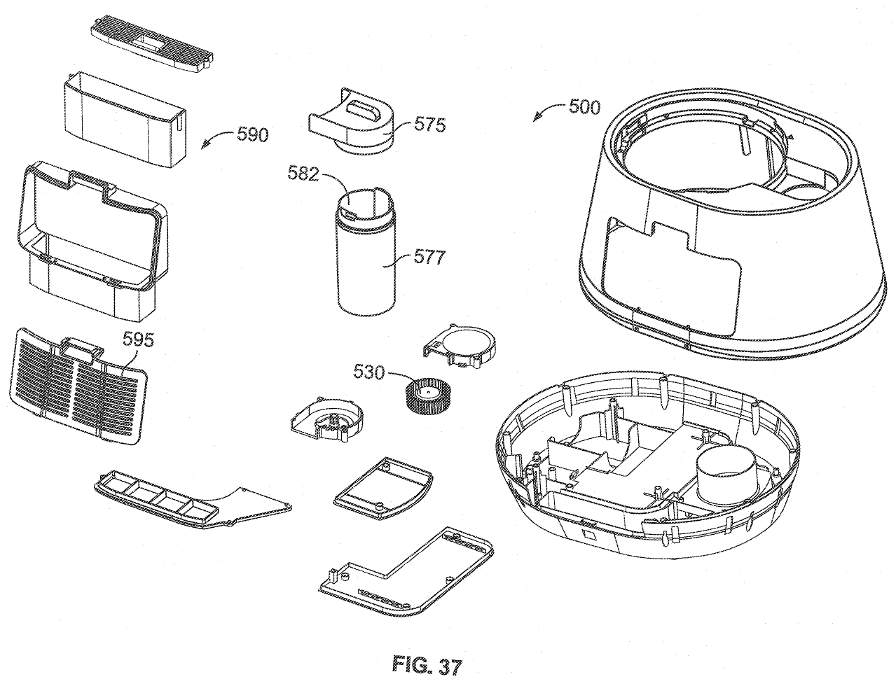

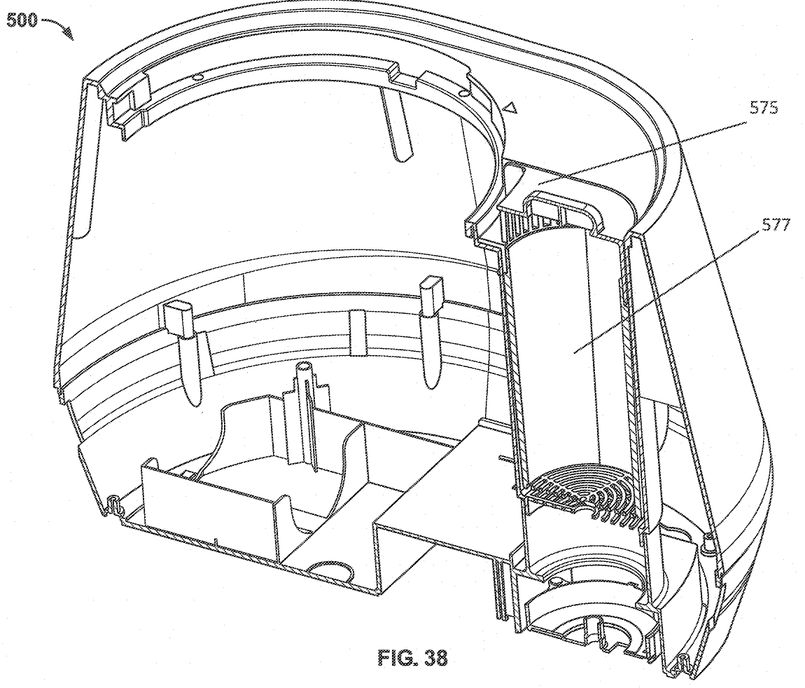

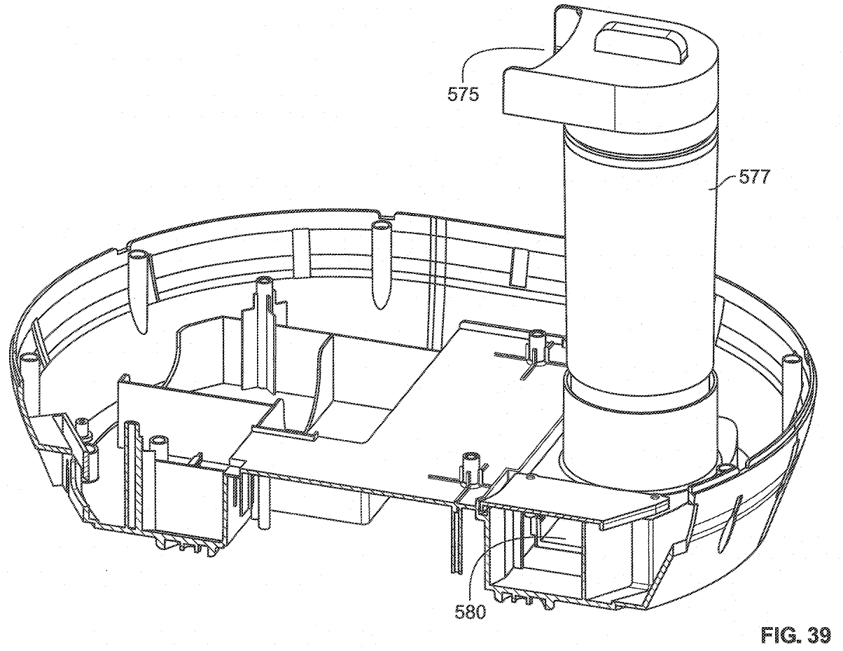

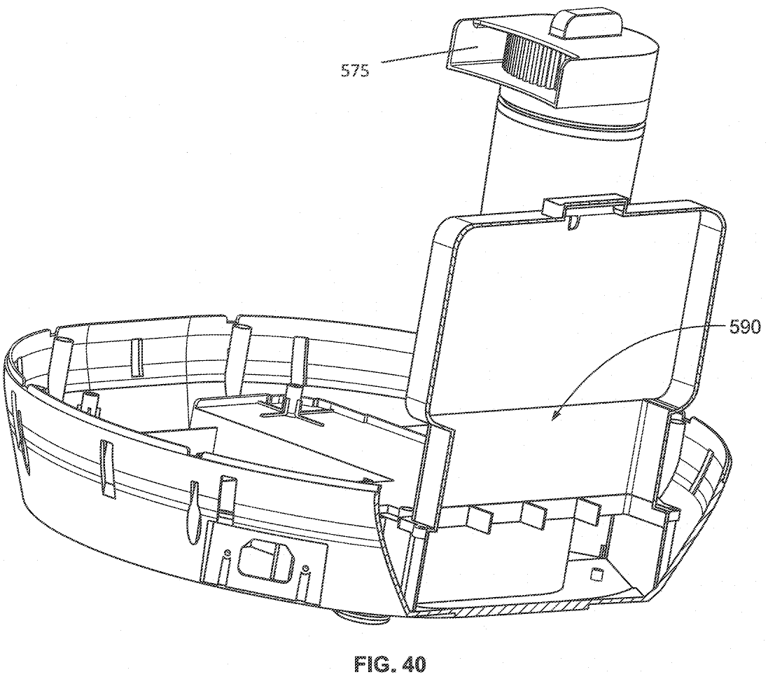

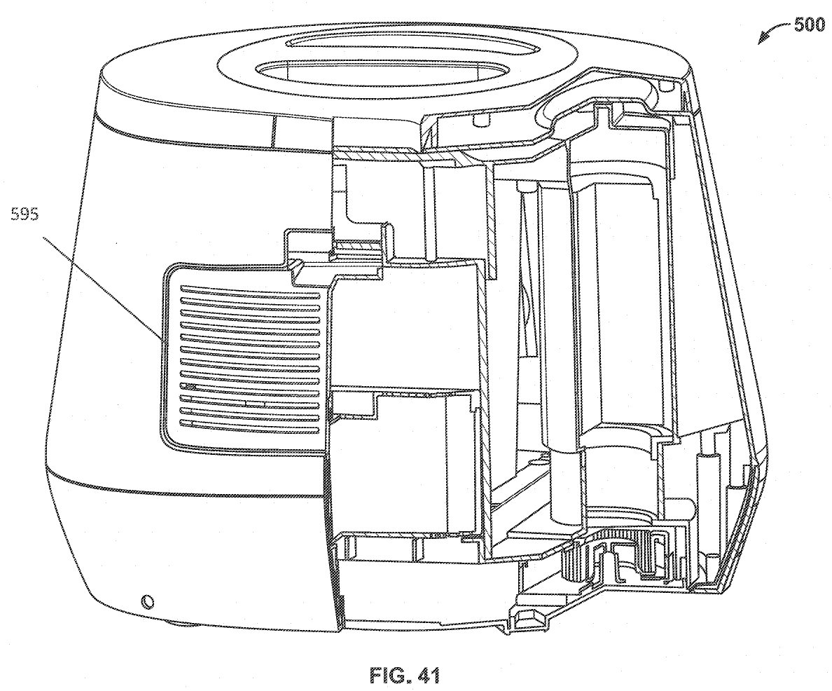

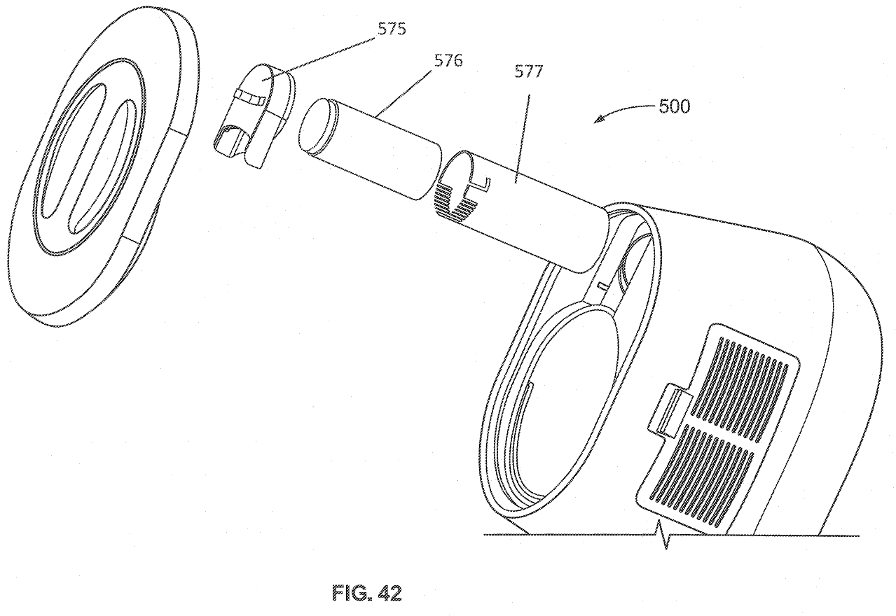

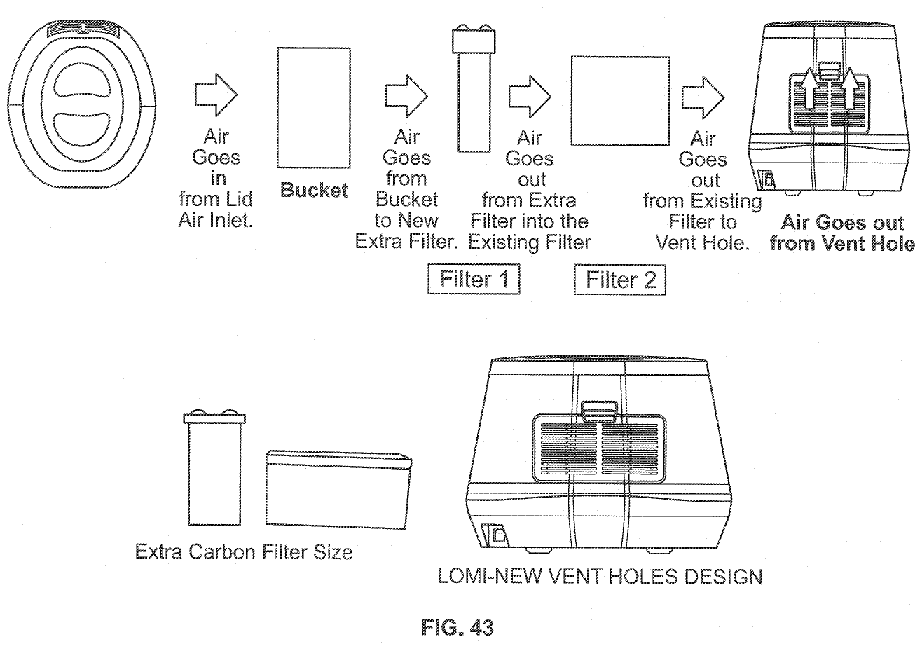

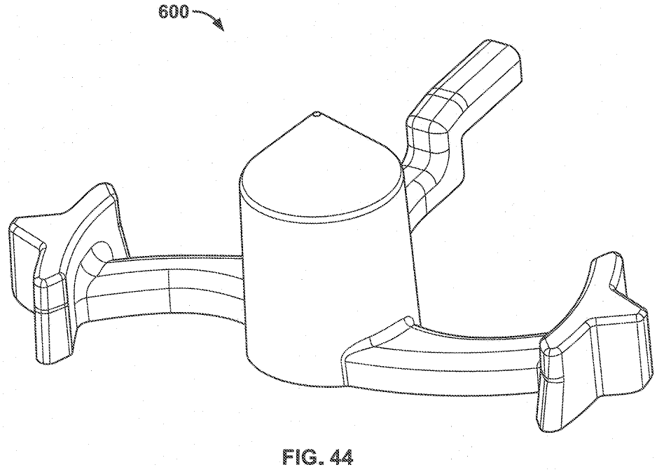

Referring now to FIGS. 32-44, there is another Composting Device 500 with a hinged lid 505 and a removable bucket. Similar functionality is not described or labeled but inferred from one embodiment to the other. The lid 505 includes a groove region 515 from the top surface that allows the consumer to access and manually open or remove the lid. The lid further includes a depression seal 520 extending from the inside surface. The depression seal rests about the top rim of the bucket and includes locking feet that hook into recess openings the inside edge of the device when the lid is closed. The depression seal may include vent openings the further assist the venting of the device during use.

The device 500 would plug into a normal electrical outlet and include a dial/activation button 180 that the consumer can use to select the appropriate setting or mode. The removable bucket includes a handle for the consumer to easily remove and return the bucket 110 from within a bucket housing 130.

Continuing to refer to the Figures, there is shown the device 100 with a lid assembly 505 defined by a top lid piece 522 and a lower lid piece 524 sandwiching a middle lid piece 526 that connect to each other. The device 100 includes a front panel 155 and a rear panel 157 that secure to each other to house various components (discussed herein below). The front and rear panels connect into a bottom housing 160 with lower front and rear trims, 162 and 164 respectively. In addition, the rear panel 157 includes a rear access door 166 removable by the consumer to allow access to the replaceable charcoal (discussed below).

While the wiring may be missing from the figures electrical connections are well known and would be easy to implement. The device 500 includes a control panel in communication with the activation button 180. The control panel is in communication with a processor to control the various housing systems and run the device. The various housing systems include an air circulation system, a heating mechanism, and grinding mechanism. In addition, the user does not need to add water to the system.

The air circulation system 200 includes a fan 530 drawing air from the bucket through the airflow cover 575 into an air inlet conduit 577, which includes a first filter system 582 through the fan 530 and out an outlet conduit 580 into an outflow air filter 590. The outflow air filter includes a filter housing positioned adjacent to the rear access door 595. Air is filtered and flows out of the filter box. The outflow air filter 210 is a reusable cartridge that can be pulled out of the device, and refilled with activated charcoal pellets, which provides the filtration. This is unique to the device, since there is no plastic waste involved in replacing the filter. Other existing devices work with disposable plastic filters causing additional waste which is counter intuitive to a device designed to compost waste.

The device 500 is a stage air purifying system. This unique ventilation system allows the user to customize for diet, preferred aroma, humidity/steam. The initial filter 576 can be set up to absorb more steam and scent for kitchen use, the second filter purifies air and eliminates remaining odor. Each filter has a removable/replaceable pouch, custom to scent and diet.

The grinding mechanism 600 includes multiple grinder blades rotated by a gear that is driven by a motor and gearbox.

In one embodiment of the invention there is provided a household composting device having a housing with a hinged lid and a composting region for receiving compostable waste material. The composting device further includes (a) a removable bucket positioned within the housing for receiving the compostable waste material; (b) an air circulation system includes a fan configured to draw air from a top portion of the bucket into an airflow cover and through a first air filter system and into a second air filter system before the air is vented out of the composting device; (c) a grinding mechanism being locating within the removable bucket; (d) a bucket housing is secured onto a pedestal around a base plate and is sized to receive the bucket, the base plate includes protruding edges sized to receive notches on a lower portion of the bucket to prevent the bucket from rotating; (e) a heating mechanism includes a heating element positioned below the base plate and configured to heat the base plate when activated; and (f) a composting cycle which when activated composts the compostable waste material positioned in the removable buck, the composting cycle including: (a) a first drying phase to heat and dry the compostable waste material, (b) a second grinding phase to grind the compostable waste material, and (c) a cooling phase.

In another aspect of this embodiment the first air filter system is configured to include a tubular filtration holder positioned above the fan such that the fan draws air through the tubular filtration holder and into an outlet conduit, and the second air filter system is connected to the outlet conduit and includes a filter box that is positioned adjacent a rear access door.

In a further aspect of this embodiment both the tubular filtration holder and the filter box are removable from the composting device but are not disposable as both the tubular filtration holder and the filter box are configured to permit the removal of spent charcoal pellets and the addition of new charcoal pellets. Furthermore, a scented pellet may be added to either the tubular filtration holder or the filter box.

In yet a further aspect of this embodiment the grinding mechanism includes multiple grinder blades rotated by a gear that is driven by a motor and gearbox. Furthermore, the grinding mechanism further includes an L shaped plate defined to have an arm positioned and secured along a groove defined in a side of the bucket, the L shaped plate further includes a leg extending towards the center of the bucket and has an upper leg section and downward extension and a lower leg section, and wherein the blades are configured such that when rotating one or more of the blades travel over the upper leg section, while the remaining blades travel under the leg upper leg section such that the movement of the blades over and under the upper leg section, grind the waste in the bucket.

In yet a further aspect of this embodiment the composting cycle includes a preliminary pulverization phase.

In another embodiment of the invention there is provided a method for composting with a household composting device having a housing with a hinged lid and a composting region for receiving compostable waste material. The method is defined by the following (a) adding compostable waste material to a removable bucket positioned in housing; (b) activating a composting cycle including the steps of: (i) a first drying phase to heat and dry the compostable waste material; (ii) a second grinding phase to grind the compostable waste material; and (iii) a final cooling phase; (c) circulating air through the system by drawing air with a fan from a top portion of the removable bucket into an airflow cover and through a first air filter system and then into a second air filter system before venting the air out of the composting device; and (d) wherein grinding of the compostable waste material is configured by having a grinding mechanism located within the removable bucket, a©(e) wherein heating of the compostable waste material is configured by having a heating mechanism configured to heat the bucket when activated.

In another aspect of this method, the first air filter system is configured to include a removable tubular filtration holder positioned above the fan such that the fan draws air through the tubular filtration holder and into an outlet conduit, and wherein the second air filter system is connected to the outlet conduit and includes a removable filter box that is positioned adjacent a rear access door and whereby the removable tubular filtration holder and the removable filter box are removed from the composting device but are not disposable as both are configured to permit the removal of spent charcoal pellets and the addition of new charcoal pellets.

In yet another aspect of this method, the grinding mechanism further includes an L shaped plate defined to have an arm positioned and secured along a groove defined in a side of the bucket, the L shaped plate further includes a leg extending towards the center of the bucket and has an upper leg section and downward extension and a lower leg section, and wherein the grinding mechanism includes blades configured such that when rotating one or more of the blades travel over the upper leg section, while the remaining blades travel under the leg upper leg section such that the movement of the blades over and under the upper leg section, grind the waste in the bucket.

In another aspect of this method, the composting cycle includes a preliminary pulverizing phase prior to the first drying phase. The pulverizing phase includes (a) increasing the temperature within the bucket while grinding the compostable waste material until an amplitude on the motor falls below a predetermined value for a predetermined time interval to define a stage one completion within the pulverizing phase; and (b) decreasing the temperature within the bucket after stage one completion is achieved.

As defined in another aspect of this method, the first drying phase to heat and dry the compostable waste material includes: (a) raising the temperature within the bucket and monitoring the humidity within the bucket to adjust the temperature to a final drying phase temperature as the humidity reaches a predetermined range; and (b) grinding the compostable material during the first drying phase.

As defined in another aspect of this method, the second grinding phase to grind the compostable waste material includes: (a) maintaining the temperature and humidity within the bucket to a predetermined constant range; and (b) grinding the compostable waste material until an amplitude on the motor falls below a predetermined value for a predetermined time interval to define a grinding phase completion.

As defined in another aspect of this method, the final cooling phase includes: (a) shutting off the heating mechanism while grinding the compostable waste material; (b) shutting off the grinding mechanism when a predetermined cooling off temperature is detected.

Another aspect of the present invention may be defined as a method for composting. The method includes a composting device defined with a composting region for receiving compostable waste material. The method may include the steps of (a) receiving compostable waste material into the composting region; (b) allowing activation of a selected composting cycle from a set of composting cycles the household composting device can perform; and (c) monitoring the household composting device's performance of the selected composing cycle.

This aspect may further define the set of composting cycles to include a bioplastics cycle for composting of compostable waste material that comprises at least some bioplastics or browns, and at least one conventional cycle. The set of composting cycles may further include one or more phases. Each phase may have one or more phase start triggers, phase end triggers, and housing system operating parameters. Each phase may be defined to enable one or more housing systems based on the household composting device system operating parameters.

There may further be define in the bioplastics cycle the following phases: (a) a drying phase to heat and dry the compostable waste material; (b) a grinding phase to grind the compostable waste material; and (c) a cooling phase to cool the compostable waste material. The bioplastics cycle may further define (a) during the drying phase the heating and drying of the compostable waste material is enabled by a heating mechanism configured to heat the composting region when activated; (b) during the grinding phase the grinding of the compostable waste material is enabled by the grinding mechanism located within the composting region; and (c) during the cooling phase the cooling of the compostable waste material is enabled by drawing warm air with a fan from a top portion of a removable bucket in the composting region and venting the warm air out of the composting device.

Yet further defined in this aspect is the grinding phase which may include (a) increasing the temperature within the bucket while grinding the compostable waste material until an amplitude on the motor falls below a predetermined value for a predetermined time interval to define a stage one completion within the grinding phase; and (b) decreasing the temperature within the bucket after stage one completion is achieved.

Yet still further defined in this aspect, the first drying phase to heat and dry the compostable waste material may further include (a) raising the temperature within the bucket and monitoring the humidity within the bucket to adjust the temperature to a final drying phase temperature as the humidity reaches a predetermined range; and (b) grinding the compostable material during the first drying phase.

The final cooling phase may be defined to include (a) shutting off the heating mechanism while grinding the compostable waste material; and (b) shutting off the grinding mechanism when a predetermined cooling off temperature is detected.

This aspect may further define the conventional cycle to include a growth cycle. The growth cycle may define (a) a drying phase to heat and dry the compostable waste material; (b) a grinding phase to grind the compostable waste material; and (c) a cooling phase to cool the compostable waste material. The operating parameters during the drying phase, grinding phase and cooling phase can cause pathogens in the compostable waste material to be materially killed but do not cause the microbes in the compostable waste material to be materially killed, such that the output of the grow cycle is broken down compostable waste material that comprises microbes but does not comprise material pathogens.

The present invention may further include another aspect of the present invention defined by having a composting device with a housing with a lid and a composting region for receiving compostable waste material. The composting device further defined to have a removable bucket positioned within the housing for receiving the compostable waste material; and an air circulation system includes a fan configured to draw air from a top portion of the bucket into an airflow cover and through a first air filter system and into a second air filter system before the air is vented out of the composting device.

This further aspect may define the first air filter system to be configured to include a tubular filtration holder positioned above the fan such that the fan draws air through the tubular filtration holder and into an outlet conduit, and the second air filter system to be configured to connect to the outlet conduit and includes a filter box that is positioned adjacent a rear access door. The tubular filtration holder and the filter box are defined to be removable from the composting device but are not disposable as both the tubular filtration holder and the filter box are configured to permit the removal of spent charcoal pellets and the addition of new charcoal pellets. This can further allow for the addition of a scented pellet to either the tubular filtration holder or the filter box.

From the foregoing and as mentioned above, it is observed that numerous variations and modifications may be effected without departing from the spirit and scope of the novel concept of the invention. It is to be understood that no limitation with respect to the embodiments illustrated herein is intended or should be inferred. It is intended to cover, by the appended claims, all such modifications within the scope of the appended claims.

We claim:

1. A composting device having a housing with a hinged lid and a composting region for receiving compostable waste material, the composting device further comprising:
a removable bucket positioned within the housing for receiving the compostable waste material;
an air circulation system includes a fan configured to draw air from a top portion of the bucket into an airflow cover and through a first air filter system and into a second air filter system before the air is vented out of the composting device;
a grinding mechanism being located within the removable bucket;
a bucket housing is secured onto a pedestal around a base plate and is sized to receive the bucket, the base plate includes protruding edges sized to receive notches on a lower portion of the bucket to prevent the bucket from rotating;
a heating mechanism includes a heating element positioned below the base plate and configured to heat the base plate when activated; and
a composting cycle which when activated composts the compostable waste material positioned in the removable buck, the composting cycle including: (a) a first drying phase to heat and dry the compostable waste material, (b) a second grinding phase to grind the compostable waste material, and (c) a cooling phase.

2. The household tabletop composting device of claim 1, wherein the first air filter system is configured to include a tubular filtration holder positioned above the fan such that the fan draws air through the tubular filtration holder and into an outlet conduit, and wherein the second air filter system is connected to the outlet conduit and includes a filter box that is positioned adjacent a rear access door.

3. The household tabletop composting device of claim 2, wherein both the tubular filtration holder and the filter box are removable from the composting device but are not disposable as both the tubular filtration holder and the filter box are configured to permit the removal of spent charcoal pellets and the addition of new charcoal pellets.

4. The household tabletop composting device of claim 3, wherein a scented pellet is added to either the tubular filtration holder or the filter box.

5. The household tabletop composting device of claim 1, wherein the grinding mechanism includes multiple grinder blades rotated by a gear that is driven by a motor and gearbox.

6. The household tabletop composting device of claim 5, wherein the grinding mechanism further includes an L shaped plate defined to have an arm positioned and secured along a groove defined in a side of the bucket, the L shaped plate further includes a leg extending towards the center of the bucket and the leg is defined to include an upper leg section, a downward extension, and a lower leg section, and wherein the blades are configured such that when rotating one or more of the blades travel over the upper leg section, while the remaining blades travel under the upper leg section such that the movement of the blades over and under the upper leg section, grind the waste in the bucket.

7. The household tabletop composting device of claim 1, wherein the composting cycle includes a preliminary pulverization phase.

8. A household composting device comprising:
a housing with a hinged lid and an internal composting region for receiving compostable waste material;
a removable bucket positioned within the housing for receiving the compostable waste material;
an air circulation system includes a fan configured to draw air from a top portion of the bucket into an airflow cover and through a first air filter system and into a second air filter system before the air is vented out of the composting device, and wherein the first air filter system is configured to include a tubular filtration holder positioned above the fan such that the fan draws air through the tubular filtration holder and into an outlet conduit, and wherein the second air filter system is connected to the outlet conduit and includes a filter box that is positioned adjacent a rear access door;
a grinding mechanism being locating within the removable bucket;
a bucket housing is secured onto a pedestal around a base plate and is sized to receive the bucket, the base plate includes protruding edges sized to receive notches on a lower portion of the bucket to prevent the bucket from rotating;
a heating mechanism includes a heating element positioned below the base plate and configured to heat the base plate when activated; and
a composting cycle which when activated composts the compostable waste material positioned in the removable buck, the composting cycle including: (a) a first drying phase to heat and dry the compostable waste material, (b) a second grinding phase to grind the compostable waste material, and (c) a cooling phase.

9. The household tabletop composting device of claim 8, wherein both the tubular filtration holder and the filter box are removable from the composting device but are not disposable as both the tubular filtration holder and the filter box are configured to permit the removal of spent charcoal pellets and the addition of new charcoal pellets.

10. The household tabletop composting device of claim 9, wherein a scented pellet is added to either the tubular filtration holder or the filter box.

11. The household tabletop composting device of claim 8, wherein the grinding mechanism includes multiple grinder blades rotated by a gear that is driven by a motor and gearbox.

12. The household tabletop composting device of claim 8, wherein the grinding mechanism further includes an L shaped plate defined to have an arm positioned and secured along a groove defined in a side of the bucket, the L shaped plate further includes a leg extending towards the center of the bucket and the leg has an upper leg section, a downward extension, and a lower leg section, and wherein the blades are configured such that when rotating one or more of the blades travel over the upper leg section, while the remaining blades travel under the upper leg section such that the movement of the blades over and under the upper leg section grinds the waste in the bucket.

13. The household tabletop composting device of claim 8, wherein the composting cycle includes a preliminary pulverization phase.

14. A method for composting with a household composting device having a housing with a hinged lid and a composting region for receiving compostable waste material, the method comprising:
adding compostable waste material to a removable bucket positioned in housing;
activating a composting cycle including the steps of:
(a) a first drying phase to heat and dry the compostable waste material;
(b) a second grinding phase to grind the compostable waste material;
(c) a final cooling phase; and
circulating air through the system by drawing air with a fan from a top portion of the removable bucket into an airflow cover and through a first air filter system and then into a second air filter system before venting the air out of the composting device; and
wherein grinding of the compostable waste material is configured by having a grinding mechanism located within the removable bucket, and
wherein heating of the compostable waste material is configured by having a heating mechanism configured to heat the bucket when activated.

15. The method of composting of claim 14, wherein the first air filter system is configured to include a removable tubular filtration holder positioned above the fan such that the fan draws air through the tubular filtration holder and into an outlet conduit, and wherein the second air filter system is connected to the outlet conduit and includes a removable filter box that is positioned adjacent a rear access door and whereby the removable tubular filtration holder and the removable filter box are removed from the composting device but are not disposable as both are configured to permit the removal of spent charcoal pellets and the addition of new charcoal pellets.

16. The method for composting of claim 15 further comprising adding a scented pellet to either the tubular filtration holder or the filter box.

17. The method for composting of claim 14, wherein the grinding mechanism further includes an L shaped plate defined to have an arm positioned and secured along a groove defined in a side of the bucket, the L shaped plate further includes a leg extending towards the center of the bucket and has an upper leg section, a downward extension, and a lower leg section, and wherein the grinding mechanism includes blades configured such that when rotating one or more of the blades travel over the upper leg section, while the remaining blades travel under the upper leg section such that the movement of the blades over and under the upper leg section, grind the waste in the bucket.

18. The method for composting of claim 14, wherein the composting cycle includes a preliminary pulverizing phase prior to the first drying phase.

19. The method for composting of claim 18, wherein the pulverizing phase includes:
increasing the temperature within the bucket while grinding the compostable waste material until an amplitude on the motor falls below a predetermined value for a predetermined time interval to define a stage one completion within the pulverizing phase; and
decreasing the temperature within the bucket after stage one completion is achieved.

20. The method for composting of claim 14, wherein the first drying phase to heat and dry the compostable waste material includes:
raising the temperature within the bucket and monitoring the humidity within the bucket to adjust the temperature to a final drying phase temperature as the humidity reaches a predetermined range; and
grinding the compostable material during the first drying phase.

21. The method for composting of claim 14, wherein the second grinding phase to grind the compostable waste material includes:
maintaining the temperature and humidity within the bucket to a predetermined constant range; and
grinding the compostable waste material until an amplitude on the motor falls below a predetermined value for a predetermined time interval to define a grinding phase completion.

22. The method for composting of claim 14, wherein the final cooling phase includes:
shutting off the heating mechanism while grinding the compostable waste material;
shutting off the grinding mechanism when a predetermined cooling off temperature is detected.

23. A method for composting with a composting device having a composting region for receiving compostable waste material, the method comprising:
receiving compostable waste material into the composting region;
allowing activation of a selected composting cycle from a set of composting cycles the household composting device can perform; and
monitoring the household composting device's performance of the selected composing cycle.

24. The method of composting of claim 23, wherein the set of composting cycles comprises a bioplastics cycle for composting of compostable waste material that comprises at least some bioplastics or browns, and at least one conventional cycle.

25. The method of composting of claim 24, wherein each of the set of composting cycles comprises one or more phases, each phase comprising one or more phase start triggers, phase end triggers and housing system operating parameters, and each phase enabling one or more housing systems based on the household composting device system operating parameters.

26. The method of composting of claim 25, where the bioplastics cycle comprises the following phases:
(b) a drying phase to heat and dry the compostable waste material;
(c) a grinding phase to grind the compostable waste material; and
(d) a cooling phase to cool the compostable waste material.

27. The method of composting of claim 26, wherein
during the drying phase the heating and drying of the compostable waste material is enabled by a heating mechanism configured to heat the composting region when activated;
during the grinding phase the grinding of the compostable waste material is enabled by the grinding mechanism located within the composting region; and
during the cooling phase the cooling of the compostable waste material is enabled by drawing warm air with a fan from a top portion of a removable bucket in the composting region and venting the warm air out of the composting device.

28. The method for composting of claim 27, wherein the grinding phase includes:
increasing the temperature within the bucket while grinding the compostable waste material until an amplitude on the motor falls below a predetermined value for a predetermined time interval to define a stage one completion within the grinding phase; and
decreasing the temperature within the bucket after stage one completion is achieved.

28. The method for composting of claim 27, wherein the first drying phase to heat and dry the compostable waste material includes:
raising the temperature within the bucket and monitoring the humidity within the bucket to adjust the temperature to a final drying phase temperature as the humidity reaches a predetermined range; and
grinding the compostable material during the first drying phase.

29. The method for composting of claim 27, wherein the final cooling phase includes:
shutting off the heating mechanism while grinding the compostable waste material; and
shutting off the grinding mechanism when a predetermined cooling off temperature is detected.

30. The method for composting of claim 24, wherein the conventional cycle comprises a grow cycle, the grow cycle comprising
(a) a drying phase to heat and dry the compostable waste material;
(b) a grinding phase to grind the compostable waste material; and
(c) a cooling phase to cool the compostable waste material; and
wherein the operating parameters during the drying phase, grinding phase and cooling phase cause pathogens in the compostable waste material to be materially killed but do not cause the microbes in the compostable waste material to be materially killed, such that the output of the grow cycle is broken down compostable waste material that comprises microbes but does not comprise material pathogens.

31. A composting device having a housing with a lid and a composting region for receiving compostable waste material, the composting device further comprising
a removable bucket positioned within the housing for receiving the compostable waste material; and
an air circulation system includes a fan configured to draw air from a top portion of the bucket into an airflow cover and through a first air filter system and into a second air filter system before the air is vented out of the composting device.

32. The composting device of claim 31, wherein the first air filter system is configured to include a tubular filtration holder positioned above the fan such that the fan draws air through the tubular filtration holder and into an outlet conduit, and wherein the second air filter system is connected to the outlet conduit and includes a filter box that is positioned adjacent a rear access door.

33. The composting device of claim 32, wherein both the tubular filtration holder and the filter box are removable from the composting device but are not disposable as both the tubular filtration holder and the filter box are configured to permit the removal of spent charcoal pellets and the addition of new charcoal pellets.

34. The composting device of claim 33, wherein a scented pellet is added to either the tubular filtration holder or the filter box.
